(19) United States
(12) Patent Application Publication
(10) Pub. No.: US 2024/0409790 A1
(43) Pub. Date: Dec. 12, 2024

(54) MULTILAYER PRESSURE-SENSITIVE ADHESIVE ASSEMBLY AND RELATED PROCESS

(71) Applicant: 3M INNOVATIVE PROPERTIES COMPANY, St. Paul, MN (US)

(72) Inventors: Roman Konietzny, Schwalmtal (DE); Pierre R. Bieber, Korschenbroich (DE); René Kuhlmann, Duesseldorf (DE); Thomas Apeldorn, Moenchengladbach (DE); Achim Boehme, Duesseldorf (DE); Michael Kempf, Neuss (DE); Stijn A.M. D'Hollander, Kemzeke (BE)

(21) Appl. No.: 18/699,456

(22) PCT Filed: Oct. 7, 2022
(86) PCT No.: PCT/IB2022/059637

§ 371 Date: Apr. 8, 2024

Related U.S. Application Data
(60) Provisional application No. 63/253,595, filed on Oct. 8, 2021.

(51) Int. Cl. C09J 7/38; C09J 7/26

(52) U.S. Cl. CPC C09J 7/387; C09J 7/26; C09J 2301/308; C09J 2301/41; C09J 2301/412

(57) ABSTRACT

The multilayer pressure sensitive adhesive assembly includes a polymeric foam layer and a first pressure sensitive adhesive layer. The polymeric foam includes a plurality of activated carbon particles. The first pressure sensitive adhesive layer includes a multi-arm block copolymer in an amount greater than 20 percent by weight, based on the weight of the first pressure sensitive adhesive layer, and at least one hydrocarbon tackifier. The multi-arm block copolymer has formula Qₙ-Y, in which Q represents an arm of the multi-arm block copolymer, each arm independently having the formula G-R, n represents the number of arms and is at least 3, and Y is the residue of a multifunctional coupling agent. Each R is independently a rubbery block including a polymerized conjugated diene, a hydrogenated derivative of a polymerized conjugated diene, or combinations thereof, and each G is a glassy block including a polymerized monovinyl aromatic monomer.

### CROSS-REFERENCE TO RELATED APPLICATION

This application claims priority to U.S. Provisional Application No. 63/253,595, filed Oct. 8, 2021, the disclosure of which is incorporated by reference in its entirety herein.

### BACKGROUND

Adhesives have been used for a variety of marking, holding, protecting, sealing and masking purposes. Adhesive tapes generally comprise a backing, or substrate, and an adhesive. Pressure-sensitive adhesives are one type of adhesive which are useful for many applications. Pressure-sensitive tapes are virtually ubiquitous in the home and workplace. In its simplest configuration, a pressure-sensitive tape comprises an adhesive and a backing, and the overall construction is tacky at the use temperature and adheres to a variety of substrates using only moderate pressure to form the bond. In this fashion, pressure-sensitive tapes constitute a complete, self-contained bonding system.

Pressure sensitive adhesives (PSAs) are well known to one of ordinary skill in the art, and according to the Pressure-Sensitive Tape Council, PSAs are known to possess properties including the following: (1) aggressive and permanent tack, (2) adherence with no more than finger pressure, (3) sufficient ability to hold onto an adherend, and (4) sufficient cohesive strength. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). PSAs do not embrace compositions merely because they are sticky or adhere to a surface. These requirements are assessed generally by means of tests which are designed to individually measure tack, adhesion (peel strength), and cohesion (shear holding power), as noted in A.V. Pocius in Adhesion and Adhesives Technology: An Introduction, 2^{nd} Ed., Hanser Gardner Publication, Cincinnati, OH, 2002. These measurements taken together constitute the balance of properties often used to characterize a PSA.

Volatile organic compounds (VOC) reduction regulations are becoming increasingly important in particular for various kind of interior applications (occupational hygiene and occupational safety) such as in the construction market or in the automotive or electronics industries. Known acrylate-based pressure sensitive adhesives typically contain notable amounts of low molecular weight organic residuals, such as un-reacted monomers arising from their polymerization process, polymerization initiator residuals, contaminations from raw materials or degradation products formed during the manufacturing process. These low molecular weight residuals qualifying as VOC may diffuse out of the adhesive tape. Known acrylate-based pressure sensitive adhesives, if not crosslinked, also generally suffer from lack of cohesive strength and excessive tendency to flow. This aspect may render the application and processability of uncrosslinked acrylate-based pressure sensitive adhesives particularly problematic, especially when made by a hotmelt process.

The reduction of organic solvent usage in the manufacturing process of pressure sensitive adhesives has quickly emerged as one straightforward means to reduce the overall VOC levels. The use of specific scavengers for organic contaminants, as described in WO 01/44400 (Yang), is another alternative way to achieve reduced VOC levels. However, the solutions for reducing overall VOC levels known from the prior art are often associated with increased manufacturing complexity and production costs.

Certain pressure sensitive adhesives are described in U.S. Pat. Appl. Pub. Nos. 2019/0345367 (Eckhardt et al.), 2018/0362811 (Waid et al.), 2019/0345366 (Eckhardt et al.), 2019/0211233 (Bieber et al.), 2010/0098962 (Hanley et al.), 2017/0313910 (Bieber et al.), and 2014/0057091 (Krawinkel et al.), and U.S. Pat. No. 9,376,599 (Welke et al.). Certain of these pressure sensitive adhesives are described as having reduced VOCs.

### SUMMARY

According to one aspect, the present disclosure relates to a multilayer pressure sensitive adhesive assembly including a polymeric foam layer and a first pressure sensitive adhesive layer adjacent to the polymeric foam layer. The polymeric foam includes a plurality of activated carbon particles distributed therein. The first pressure sensitive adhesive includes a multi-arm block copolymer in an amount greater than 20 percent by weight, based on the total weight of the first pressure sensitive adhesive layer, and at least one hydrocarbon tackifier. The multi-arm block copolymer has formula Qₙ-Y, in which Q represents an arm of the multi-arm block copolymer and each arm independently has the formula G-R, n represents the number of arms and is a whole number of at least 3, and Y is the residue of a multifunctional coupling agent. Each R is independently a rubbery block including a polymerized conjugated diene, a hydrogenated derivative of a polymerized conjugated diene, or combinations thereof, and each G is a glassy block including a polymerized monovinyl aromatic monomer.

In another aspect, the present disclosure is directed to a process for manufacturing a multilayer pressure sensitive adhesive assembly as described above, which includes compounding the multi-arm block copolymer and the at least one hydrocarbon tackifier to form a pressure sensitive adhesive formulation, melt co-extruding the polymeric foam layer and the first pressure sensitive adhesive layer to form the multilayer pressure sensitive adhesive assembly, and optionally crosslinking the multilayer pressure sensitive adhesive assembly with electron beam irradiation.

According to still another aspect, the present disclosure relates to the use of a multilayer pressure sensitive adhesive assembly as described above for industrial applications, in some embodiments, interior applications, for example, construction market applications, automotive applications, or electronic applications.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The terms “crosslinked” and “crosslinking” refers to joining polymer chains together by covalent chemical bonds to form a network polymer. A crosslinked polymer is generally characterized by insolubility but may be swellable in the presence of an appropriate solvent. The term “crosslinked elastomer” includes partially crosslinked.

The term “(meth)acrylate” refers to acrylate and/or methacrylate.

The terms “acrylic” and “polyacrylate” refer to both acrylic and methacrylic polymers, oligomers, and monomers.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

### DETAILED DESCRIPTION

According to a first aspect, the present disclosure relates to a multilayer pressure sensitive adhesive assembly including a polymeric foam layer and a first pressure sensitive adhesive layer adjacent to the polymeric foam layer, wherein the polymeric foam includes a plurality of activated carbon particles distributed therein, and wherein the first pressure sensitive adhesive comprises a multi-arm block copolymer in an amount greater than 20 percent by weight, based on the total weight of the first pressure sensitive adhesive layer, and at least one hydrocarbon tackifier. The multi-arm block copolymer has formula Qₙ-Y, in which Q represents an arm of the multi-arm block copolymer and each arm independently has the formula G-R, n represents the number of arms and is a whole number of at least 3, and Y is the residue of a multifunctional coupling agent. Each R is independently a rubbery block including a polymerized conjugated diene, a hydrogenated derivative of a polymerized conjugated diene, or combinations thereof, and each G is a glassy block including a polymerized monovinyl aromatic monomer. In the context of the present disclosure, it has been surprisingly found that the multilayer pressure sensitive adhesive assembly of the present disclosure provides outstanding robustness and excellent characteristics and performance as to overall VOC levels reduction. These outstanding characteristics are believed to be due, at least in part, to the specific combination of the first pressure sensitive adhesive layer composition as described above, and the presence of a plurality of activated carbon particles distributed in the polymeric foam layer, which function as an efficient adsorbent material for volatile organic compounds from the pressure sensitive adhesive assembly.

In some advantageous aspects, the multilayer pressure sensitive adhesive assembly according to the present disclosure is characterized by very low odor or a substantial absence of perceptible odor. In some aspects, the multilayer pressure sensitive adhesive assembly according to the present disclosure is characterized by further providing excellent characteristics and performance as to overall fogging levels reduction. The low fogging characteristics typically translate into improved resistance of outgassed components to condensation, as well as improved thermal stability of the corresponding pressure sensitive adhesive assembly.

In addition, the multilayer pressure sensitive adhesive assembly as described herein provides surprisingly good overall balance of adhesive and cohesive characteristics (in particular with respect to peel forces and static shear resistance) on various types of substrates, including LSE and MSE substrates, and in particular on automotive clear coats, on plastic substrates such as e.g. TPO, PP or PP/EPDM commonly used in the automotive industry, automotive varnishes or automotive paints.

In some advantageous aspects of the present disclosure according to which the multilayer pressure sensitive adhesive assembly is obtained, for example, by melt co-extrusion, in particular hotmelt co-extrusion, of the polymeric foam layer and the first pressure sensitive adhesive layer, the resulting multilayer pressure sensitive adhesive assemblies as described herein provide excellent resistance to delamination, even at high temperatures such as 70° C. and higher. According to the same advantageous aspect, the multilayer pressure sensitive adhesive assemblies according to the present disclosure beneficially provide excellent surface and interface properties, which is particularly surprising in those executions where the polymeric foam layer is foamed with expandable microspheres. Without wishing to be bound by theory, it is believed that these outstanding properties are due to the compounds used to form the polymeric foam layer and the first pressure sensitive layer being in melted state at the time the co-extrusion process step is performed. This results in a smoother surface of the first pressure sensitive layer outer surface and a smoother interface (e.g., void-free interface) between the polymeric foam layer and the first pressure sensitive layer. The excellent surface and interface properties of the multilayer pressure sensitive adhesive assemblies according to the present disclosure can result into better wetting on the substrate to adhere to and therefore into improved adhesion properties.

As such, the multilayer pressure sensitive adhesive assemblies according to the present disclosure are particularly suited for (e.g., industrial) interior applications, more in particular for construction market applications, automotive applications, and electronic applications. In the context of automotive applications, the multilayer pressure sensitive adhesive assemblies as described herein may find particular use for adhering, for example, automotive body side moldings, weather strips, or rearview mirrors. In some aspects, the multilayer pressure sensitive adhesive assemblies according to the present disclosure are provided with advantageous low fogging characteristics, which are suitable, for example, for electronic applications.

In the context of the present disclosure, the expression “low surface energy substrates” is meant to refer to those substrates having a surface energy of less than 34 dynes per centimeter. Included among such materials are polypropylene, polyethylene [e.g., high density polyethylene (HDPE), low density polyethylene (LDPE), and liner low density polyethylene (LLDPE)], and blends of polypropylene (e.g., PP/EPDM, TPO).

In the context of the present disclosure, the expression “medium surface energy substrates” is meant to refer to those substrates having a surface energy in a range from 34 to 70 dynes per centimeter, typically from 34 to 60 dynes per centimeter, and more typically from 34 to 50 dynes per centimeter. Included among such materials are polyamide 6 (PA6), acrylonitrile butadiene styrene (ABS), polycarbonate (PC)/ABS blends, PC, PVC, polyamide (PA), polyurethane (PUR), thermoplastic elastomers (TPE), polyoxymethylene (POM), polystyrene, poly(methyl methacrylate) (PMMA), clear coat surfaces, in particular clear coats for vehicles like a car or coated surfaces for industrial applications and composite materials like fiber reinforced plastics. The surface energy is typically determined from contact angle measurements as described for example in ASTM D7490-08.

In a typical aspect, a rubbery block for use herein exhibits a glass transition temperature (Tg) of less than room temperature. In some aspects, the Tg of the rubbery block is less than about 0° C., or even less than about −10° C. In some aspects, the Tg of the rubbery block is less than about −40° C., or even less than about −60° C.

In a typical aspect, a glassy block for use herein exhibits a Tg of greater than room temperature. In some embodiments, the Tg of the glassy block is at least about 40° C., at least about 60° C., at least about 80° C., or even at least about 100° C.

The terms “glass transition temperature” and “Tg” are used interchangeably and refer to the glass transition temperature of a material or a mixture. Unless otherwise indicated, glass transition temperature values are determined by Differential Scanning Calorimetry (DSC).

The multilayer pressure sensitive adhesive assembly of the present disclosure comprises a polymeric foam layer adjacent to the first pressure sensitive adhesive layer. Any commonly known polymeric foam and material for forming a polymeric foam may be used in the context of the present disclosure. Suitable polymeric foams and materials for forming a polymeric foam for use herein may be easily identified by those skilled in the art, in the light of the present disclosure.

In the context of the present disclosure, the term “polymeric foam” is meant to designate a material based on a polymer and which material comprises voids, typically in an amount of at least 5% by volume, typically from 10% to 80% by volume, from 10% to 65%, from 15% to 45%, or from 20% to 45% by volume. The voids may be obtained by any of the known methods such as cells formed by gas. Alternatively, the voids may result from the incorporation of hollow fillers, such as hollow polymeric particles, hollow glass microspheres, hollow ceramic microspheres. According to another alternative aspect, the voids may result from the incorporation of heat expandable microspheres, for example, pentane filled expandable microspheres. The heat expandable microspheres for use herein may be expanded when the polymer melt passes an extrusion die. Polymer mixtures containing expandable microspheres may also be extruded at temperatures below their expansion temperature and expanded in a later step by exposing the tape to temperatures above the expansion temperature of the microspheres. Alternatively, the voids can result from the decomposition of chemical blowing agents. A polymeric foam layer typically has a density in a range from 0.30 g/cm³ to 1.5 g/cm³, from 0.35 g/cm³ to 1.10 g/cm³, or from 0.40 g/cm³ to 0.95 g/cm³.

In some aspects, the polymeric foam layer has viscoelastic properties at room temperature. In some other aspects, the foam may comprise a thermoplastic foam. In some other aspects, the foam may comprise a thermoset foam. Examples of useful foams are also described in, e.g., the Handbook of Polymer Foams, David Eaves, editor, published by Shawbury, Shrewsbury, Shropshire, UK: Rapra Technology, 2004.

According to some aspects of the multilayer pressure sensitive adhesive assembly, the polymeric foam layer comprises a polymer base material comprising at least one of a polyacrylate, a polyurethane, a polyolefin, a polyamine, a polyamide, a polyester, a polyether, a polyisobutylene, a polystyrene, natural rubber, a rubber-based elastomeric material, a polyvinyl, or polyvinylpyrrolidone, and can include any combinations, copolymers, or mixtures thereof. In some aspects, the polymeric foam layer comprises a polymer base material comprising at least one of a polyacrylate, a polyurethane, or any combination, copolymer, or mixture thereof. In some aspects, the polymeric foam layer comprises a polyacrylate or a mixture of polyacrylates.

In some aspects of the multilayer pressure sensitive adhesive assembly, the polymeric foam comprises a polyacrylate whose main monomer component comprises a linear or branched alkyl (meth)acrylate ester, for example, a non-polar linear or branched alkyl (meth)acrylate ester having a linear or branched alkyl group having from 1 to 32, from 1 to 20, or from 1 to 15 carbon atoms. Useful linear or branched alkyl (meth)acrylate esters include methyl (meth)acrylate, ethyl (meth)acrylate, n-propyl (meth)acrylate, isopropyl (meth)acrylate, n-butyl acrylate, isobutyl acrylate, tert-butyl (meth)acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, octyl (meth)acrylate, iso-octyl (meth)acrylate, 2-octyl(meth)acrylate, 2-ethylhexyl (meth)acrylate, decyl (meth)acrylate, lauryl (meth)acrylate, 2-propylheptyl (meth)acrylate, stearyl (meth)acrylate, isobornyl acrylate, benzyl (meth)acrylate, octadecyl acrylate, nonyl acrylate, dodecyl acrylate, isophoryl (meth)acrylate, and any combinations or mixtures thereof. In some aspects, the linear or branched alkyl (meth)acrylate ester comprises at least one of 2-ethylhexyl (meth)acrylate, iso-octyl (meth)acrylate, 2-propylheptyl (meth)acrylate, butyl acrylate, and any combinations or mixtures thereof. In some aspects, the linear or branched alkyl (meth)acrylate ester comprises at least one of 2-ethylhexyl acrylate or iso-octyl acrylate.

According to an aspect of the multilayer pressure sensitive adhesive assembly, the polymeric foam layer comprises a polyacrylate which further comprises a comonomer such as acrylic acid, acrylamide, methacrylamide, N,N-dimethyl acrylamide, itaconic acid, methacrylic acid, acrylonitrile, methacrylonitrile, vinyl acetate, N-vinyl pyrrolidone, isobornyl acrylate, cyano ethyl acrylate, N-vinylcaprolactam, maleic anhydride, hydroxyalkylacrylates, N,N-dimethyl aminoethyl (meth)acrylate, N,N-diethylacrylamide, beta-carboxyethyl acrylate; vinyl esters of neodecanoic, neononanoic, neopentanoic, 2-ethylhexanoic, or propionic acids; vinylidene chloride, styrene, vinyl toluene, alkyl vinyl ethers, and any combinations or mixtures thereof.

According to another aspect of the multilayer pressure sensitive adhesive assembly, the polymeric foam layer comprises polyacrylate which further comprises a polar comonomer, such as a polar acrylate. Suitable comonomers include acrylic acid, methacrylic acid, itaconic acid, hydroxyalkyl acrylates, acrylamides and substituted acrylamides, acrylamines and substituted acrylamines, and any combinations or mixtures thereof. In some aspects, the polar comonomer is acrylic acid.

According to the present disclosure, the polymeric foam for use in the multilayer pressure sensitive adhesive assembly comprises a plurality of activated carbon particles distributed therein. Any commonly known activated carbon particles may be used in the context of the present disclosure. Suitable activated carbon particles for use herein may be easily identified by those skilled in the art, in the light of the present disclosure.

In the context of the present disclosure, it has been surprisingly found that the presence of a plurality of activated carbon particles distributed in the polymeric foam layer strongly contributes to an overall decrease of volatile organic compounds emissions from the pressure sensitive adhesive assembly. The plurality of activated carbon particles are believed to function as efficient adsorbent material for volatile organic compounds emitted from the pressure sensitive adhesive assembly. These volatile organic compounds are typically low molecular weight organic residuals, such as un-reacted monomers arising from the polymerization process of the polymeric foam, polymerization initiator residuals, contaminations from raw materials, or degradation products formed during the manufacturing or the post-processing of the pressure sensitive adhesive assembly. The plurality of activated carbon particles for use herein are capable of adsorbing the volatile organic compounds by chemisorption and/or physisorption.

It has further been found that the plurality of activated carbon particles function as a reinforcing material of the polymeric foam layer. Moreover, the activated carbon particles may be used as rheology-modifying agent of the polymeric foam layer, which allows fine-tuning the ultimate desired properties of the resulting multilayer pressure sensitive adhesive assembly, in particular its mechanical properties. The activated carbon particles have also been found to have only little (if no) influence on the modulus properties (in particular the Young's modulus) of the polymeric foam layer due in particular to the substantially neutral nature of the particle surface, the relative softness (and frangible nature) of the particles, and the limited interaction of the particles with the surrounding polymer. In contrast, carbon black particles strongly modify the modulus properties of the polymeric foam layer due in particular to the substantially acidic nature of the particle surface, the relative hardness of the carbon black particles, and the strong interaction of the particles with the surrounding polymer.

When compared to carbon black particles, activated carbon particles allow forming true black polymeric foam layers when used in a relatively high amount, and this without detrimentally affecting the properties of the polymeric foam layer and the resulting multilayer pressure sensitive adhesive assembly (in particular, its mechanical properties). In contrast, carbon black particles when used in relatively high amount detrimentally impact the properties of the polymeric foam layer and the resulting multilayer pressure sensitive adhesive assembly. Furthermore, the use of activated carbon particles reduces or obviates the need for applying a vacuum degassing operation while trying to obtain a multilayer pressure sensitive adhesive assembly provided with reduced VOC level characteristics.

Activated carbon is carbon that has been processed to make it highly porous (i.e., having a large number of pores per unit volume), which thus imparts a high surface area. Activated carbons may be generated from a variety of materials; however, most commercially available activated carbons are made from peat, coal, lignite, wood, and coconut shells. Based on the source, the carbon can have different pore sizes, ash content, surface order, and/or impurity profiles. Coconut shell-based carbon has predominantly a microporus pore size, whereas a wood-based activated carbon has a predominately mesoporous or macroporous pore size. Coconut shell- and wood-based carbon typically have ash contents less than about 3% by weight, whereas coal-based carbons typically have ash contents of 4% to 10% by weight or even higher.

Commercially available activated carbon particles include: activated wood-based carbon available under the trade designation “NUCHAR RGC”, by Mead Westvaco Corp, Richmond, VA; wood-based carbon available under the trade designation “AQUAGUARD” by Mead Westvaco Corp; activated coconut shell-based carbon available under the trade designation “KURARAY PGW” by Kuraray Chemical Co., LTD, Okayama, Japan; and coal-based carbon available under the trade designations “CARBSORB” and “FILTRASORB” by Calgon Carbon Corp., Pittsburgh, PA.

In some aspects, the activated carbon particles are distributed throughout the polymeric foam layer. In some aspects, the activated carbon particles are distributed substantially uniformly through a cross-section of the polymeric foam layer, meaning that the activated carbon particles are present at roughly the same concentration (e.g., within 10%) throughout the cross-section of the polymeric foam layer.

In some aspects, the activated carbon particles for use herein are porous and have an individual specific surface area comprised between 100 and 2000 m²/g, between 200 and 1500 m²/g, between 500 and 1400 m²/g, between 600 and 1200 m²/g, or between 700 and 1000 m²/g, when measured according to the BET (Brunauer Emmet Teller) nitrogen absorption test method described for example in Test Method ISO 9277:2010.

In some aspects, the activated carbon particles are predominantly microporous, and typically have pore widths no greater than 2 nanometers. In some aspects, at least 75%, at least 80%, at least 85%, at least 90%, or at least 95% of the pores of the activated carbon particles have a pore width no greater than 2 nanometers.

In some aspects of the multilayer pressure sensitive adhesive assembly of the present disclosure, the amount of activated carbon particles in the polymeric foam is at least 0.1 weight percent (wt %), at least 0.5 wt %, at least 1 wt %, at least 3 wt %, at least 5 wt %, or at least 10 wt %, based on the weight of the polymeric foam. In some aspects, the amount of activated carbon particles in the polymeric foam is no greater than 25 wt %, no greater than 20 wt %, or no greater than 15%, based on the weight of the polymeric foam. In some aspects, the amount of activated carbon particles in the polymeric foam is in a range from 0.1 wt % to 25 wt %, from 1 wt % to 20 wt %, from 1 wt % to 15 wt %, or from 2 wt % to 10 wt %, based on the weight of the polymeric foam.

In some aspects, the polymeric foam of the present disclosure may further comprise, as an optional ingredient, a filler material. Such fillers may be advantageously used, for example, to increase the mechanical stability of the polymeric foam and may also increase its shear and peel force resistance.

Any filler material commonly known to those skilled in the art may be used in the context of the present disclosure. Typical examples of filler material that can be used herein include expanded perlite, microspheres, expandable microspheres, ceramic spheres, zeolites, clay fillers, glass beads, hollow inorganic beads, silica type fillers, hydrophobic silica type fillers, hydrophilic silica type fillers, fumed silica, fibers (e.g., glass fibers, carbon fibers, graphite fibers, silica fibers, ceramic fibers), electrically and/or thermally conducting particles, nanoparticles (e.g., silica nanoparticles), and any combinations thereof.

In some aspects, the polymeric foam comprises a material selected from the group consisting of microspheres, expandable microspheres, pentane-filled expandable microspheres, gaseous cavities, glass beads, glass microspheres, glass bubbles and any combinations or mixtures thereof.

When present, the filler material for use herein may be used in the polymeric foam in any suitable amounts. In some aspects, the filler material is present in an amount up to 30 parts by weight, up to 25 parts by weight, or up to 20 parts by weight of the polymeric foam. In some aspects, this amount is typically at least 1 part by weight, or at least 3 parts by weight of the polymeric foam. In some aspects, the filler material is present in amounts in a range of from 1 to 20 parts, from 3 to 15 parts by weight, or from 5 to 13 parts by weight of the polymeric foam. In some aspects, the filler material is present in a range of from 1 to 20 parts, from 2 to 15 parts by weight, or from 2 to 10 parts by weight of the polymeric foam.

The polymeric foam for use in the present disclosure may further comprise, as an optional ingredient, a crosslinking additive (also referred to as crosslinking agent and crosslinker). A crosslinker may be used to increase the cohesive strength and the tensile strength of the polymeric material. Suitable crosslinking additives for use herein may be easily identified by those skilled in the art, in the light of the present disclosure. Examples of crosslinking methods include thermal, moisture, photosensitive, actinic, or ionizing radiation crosslinking.

Thermal crosslinkers may be used, optionally in combination with suitable accelerants and retardants. Suitable thermal crosslinkers for use herein include isocyanates, particularly trimerized isocyanates and/or sterically hindered isocyanates that are free of blocking agents, and epoxide compounds such as epoxide-amine crosslinker systems. Advantageous crosslinker systems and methods are described e.g. in the descriptions of DE202009013255 U1, published Mar. 18, 2010, U.S. Pat. No. 5,877,261 (Harder et al.), U.S. Pat. No. 7,910,163 (Zollner et al.), U.S. Pat. No. 7,935,383 (Zollner et al.), U.S. Pat. No. 8,449,962 (Prenzel et al.), U.S. Pat. No. 8,802,777 (Zollner et al.), U.S. Pat. No. 10,457,791 (Czerwonatis et al.), U.S. Pat. No. 9,505,959 (Grittner et al.), and U.S. Pat. No. 9,896,605 (Zollner et al.), and U.S. Pat. Appl. Pub. No. 2011/0274843 (Grittner et al.). Suitable accelerants and retardant systems for use herein are described, for example, U.S. Pat. No. 9,200,129 (Czerwonatis et al.). Suitable thermal crosslinkers for use herein include epoxycyclohexyl derivatives, in particular epoxycyclohexyl carboxylate derivatives, for example, (3,4-epoxycyclohexane)methyl 3,4-epoxycyclohexylcarboxylate, commercially available from Cytec Industries Inc. under tradename UVACURE 1500. According to a particular aspect, the polymeric foam for use herein may comprise (co)polymers or copolymers crosslinkable with epoxide groups. Correspondingly, at least part of the monomers or comonomers used may advantageously be functional monomers crosslinkable with epoxide groups. Monomers with acid groups (especially carboxylic, sulphonic or phosphonic acid groups) and/or hydroxyl groups and/or acid anhydride groups and/or epoxide groups and/or amine groups, in particular monomers containing carboxylic acid groups, may be suitably used. Suitable functional monomers are described, for example, in U.S. Pat. No. 9,688,886 (Ring et al.).

According to another aspect of the present disclosure, the crosslinking is initiated by ultraviolet radiation, or ionizing radiation such as gamma radiation or electron beam (the use of separate crosslinking agents being optional in the case of ionizing radiation).

Examples of crosslinking additives for use herein include compounds having multiple (meth)acryloyl groups, for example, di(meth)acrylates, tri(meth)acrylates, tetra(meth)acrylates, penta(meth)acrylates, and combinations thereof. In some aspects, the multifunctional (meth)acrylate compound has the following Formula:

H₂C═C(R′)—(CO)—O—R²—[O—(CO)—(R′)C═CH₂]n

wherein R¹ is hydrogen or methyl; n is 1, 2, 3 or 4; and R² is an alkylene, arylene, heteroalkylene, or any combination thereof. In some aspects, the crosslinking additive for use herein is a multifunctional (meth)acrylate compound selected from the group consisting of 1,6-hexanediol di(meth)acrylate, trimethylolpropane tri(meth)acrylate, and any combinations or mixtures thereof.

Further examples of crosslinking additives for use herein include substituted triazines such as 2,4-bis(trichloromethyl)-6-(4-methoxyphenyl)-s-triazine and 2,4-bis(trichloromethyl)-6-(3,4-dimethoxyphenyl)-s-triazine, as described in U.S. Pat. No. 4,329,384 (Vesley et al.) and 4,330,590 (Vesley). Another class of useful crosslinking additives are the copolymerizable mono-ethylenically unsaturated aromatic ketone comonomers free of ortho-aromatic hydroxyl groups such as those disclosed in U.S. Pat. No. 4,737,559 (Kellen et al.). Specific examples include para-acryloxybenzophenone, para-acryloxyethoxybenzophenone, para-N-(methylacryloxyethyl)-carbamoylethoxybenzophenone, para-acryloxyacetophenone, ortho-acrylamidoacetophenone, and acrylated anthraquinones. Yet another suitable crosslinking additive is 1,5-bis(4-benzoylbenzoxy) pentane. Also suitable are hydrogen-abstracting carbonyls such as anthraquinone, benzophenone, and derivatives thereof, as disclosed in U.S. Pat. No. 4,181,752 (Martens et al.).

The crosslinking additive, if present, may be used, for example, in an amount of up to 40 wt %, based on the weight of the polymeric foam. In some aspects, the crosslinking additive may be used in an amount up to 20 wt %, up to 15 wt %, up to 10 wt %, or up to 5 wt %, based on the weight of the polymeric foam. The amount of crosslinking additive can be for example, in the range from 0.1 wt % to 10 wt %, from 0.5 wt % to 8 wt %, from 1 wt % to 6 wt %, or from 2 wt % to 5 wt %, based on the weight of the polymeric foam. The polymeric foam may also be free of any of the crosslinking additives described above.

In some aspects of the multilayer pressure sensitive adhesive assembly, the polymeric foam comprises:
a) from 60 to 100 wt %, from 70 to 95 wt %, from 80 to 95 wt % or from 85 to 95 wt %, of a free-radically polymerizable monomer unit, in particular one or more (meth)acrylate ester monomer unit(s), based on the weight of the polymeric foam;
b) from 0 to 40 wt %, from 5 to 30 wt %, from 5 to 20 wt %, or from 5 to 15 wt %, of a co-monomer unit having an ethylenically unsaturated group, in particular one or more acrylic acid monomer unit(s), based on the weight of the polymeric foam; and
c) from 0 to 20 wt %, from 1 to 15 wt %, from 2 to 13 wt %, or from 2 to 10 wt %, of hollow filler particles, in particular hollow filler particles selected from the group consisting of expandable microspheres, pentane filled expandable microspheres, glass beads, glass microspheres, glass bubbles, and combinations thereof based on the weight of the polymeric foam.

According to some aspects of the multilayer pressure sensitive adhesive assembly according to present disclosure, the polymeric foam comprises:
a) from 60 to 100 wt %, from 70 to 95 wt %, from 80 to 95 wt %, or from 85 to 95 wt %, of one or more (meth)acrylate ester monomer units having a linear or branched alkyl group comprising from 1 to 32, from 1 to 20, or from 1 to 15 carbon atoms, based on the weight of the polymeric foam;
b) from 0 to 40 wt %, from 5 to 30 wt %, from 5 to 20 wt %, or from 5 to 15 wt %, of one or more acrylic acid monomer unit(s), based on the weight of the polymeric foam; and
c) from 0 to 20 wt %, from 1 to 15 wt %, from 2 to 13 wt %, or from 2 to 10 wt %, of expandable microspheres, such as pentane filled expandable microspheres, based on the weight of the polymeric foam.

The polymeric foam for use herein and the associated polymer base material may be prepared by any conventional free radical polymerization method, commonly known to those skilled in the art. Useful methods include solution, radiation, bulk, dispersion, emulsion, solventless, and suspension processes.

In a radiation polymerization, a monomer mixture may be irradiated, for example, with ultraviolet (UV) rays, in the presence of a photopolymerization initiator (i.e., photoinitiators). Suitable photoinitiators include those available under the trade designations OMNIRAD from IGM Resins (Waalwijk, The Netherlands) and include 1-hydroxycyclohexyl phenyl ketone (OMNIRAD 184), 2,2-dimethoxy-1,2-diphenylethan-1-one (OMNIRAD 651), bis(2,4,6-trimethylbenzoyl)phenylphosphineoxide (OMNIRAD 819), 1-[4-(2-hydroxyethoxy)phenyl]-2-hydroxy-2-methyl-1-propane-1-one (OMNIRAD 2959), 2-benzyl-2-dimethylamino-1-(4-morpholinophenyl)butanone (OMNIRAD 369), 2-methyl-1-[4-(methylthio)phenyl]-2-morpholinopropan-1-one (OMNIRAD 907), and 2-hydroxy-2-methyl-1-phenyl propan-1-one (OMNIRAD 1173), oligo[2-hydroxy-2-methyl-1-[4-(1-methylvinyl)phenyl]propanone] obtained from IGM Resins under the trade designation ESACURE KIP 150, and difunctional alpha-hydroxy ketones obtained from IGM Resins under the trade designations ESACURE ONE and ESACURE KIP 160 (2-hydroxy-1-[4-[4-(2-hydroxy-2-methylpropionyl)phenoxy]phenyl]-2-methylpropanone). A difunctional alpha-hydroxy ketone means that the photoinitiator includes two alpha-hydroxy ketone groups. A multifunctional alpha-hydroxy ketone means that the photoinitiator includes two or more alpha-hydroxy ketone groups. Additional suitable photoinitiators include benzyl dimethyl ketal, 2-methyl-2-hydroxypropiophenone, benzoin methyl ether, benzoin isopropyl ether, anisoin methyl ether, aromatic sulfonyl chlorides, photoactive oximes, and combinations thereof. When used, a photoinitiator is typically present in an amount from about 0.01 to about 5.0 parts, from 0.1 to 1 part, or from 0.1 to 0.5 parts, per 100 parts by weight of total monomer.

In some aspects, the polymeric foam for use herein and the associated polymer base material is prepared by solventless processes. Solventless polymerization methods, such as the continuous free radical polymerization method described in U.S. Pat. Nos. 4,619,979 and 4,843,134 (Kotnour et al.), and the method for manufacturing foamed PSA described in U.S. Pat. No. 7,879,441 (Gehlsen et al.) may also be utilized to prepare the polymeric foam and the associated polymer base material.

The first pressure sensitive adhesive in the multilayer pressure sensitive adhesive assembly of the present disclosure includes a multi-arm block copolymer having the formula Qₙ-Y, wherein Q represents an arm of the multi-arm block copolymer and each arm independently has the formula G-R, n represents the number of arms and is a whole number of at least 3, and Y is the residue of a multifunctional coupling agent, and wherein each R is independently a rubbery block comprising a polymerized conjugated diene, a hydrogenated derivative of a polymerized conjugated diene, or combinations thereof, and each G is independently a glassy block comprising a polymerized monovinyl aromatic monomer.

In some aspects, n ranges from 3 to 10 or from 3 to 5. In some aspects, n is at least 4, and in some aspects, n is at least 6. In some aspects, the conjugated diene has 4 to 12 carbon atoms. Examples of conjugated dienes include butadiene, isoprene, ethylbutadiene, phenylbutadiene, piperylene, pentadiene, hexadiene, ethylhexadiene, and dimethylbutadiene. The polymerized conjugated dienes may be used individually or as copolymers with each other. In some aspects, the rubbery block R of at least one arm comprises a polymerized conjugated diene selected from the group consisting of isoprene, butadiene, ethylene butadiene copolymers, hydrogenated derivatives of polyisoprene or polybutadiene, and any combinations or mixtures thereof. In some aspects, the rubbery blocks R of each arm comprise a polymerized conjugated diene selected from the group consisting of isoprene, butadiene, ethylene butadiene copolymers, hydrogenated derivatives of polyisoprene or polybutadiene, and combinations or mixtures thereof. In some aspects, at least one of the rubbery blocks R of the multi-arm block copolymer having the formula Qₙ-Y comprises a polymerized conjugated diene selected from the group consisting of isoprene, butadiene, and any combinations thereof. In some aspects, each of the rubbery blocks R of the multi-arm block copolymer having the formula Qₙ-Y comprises a polymerized conjugated diene selected from the group consisting of isoprene, butadiene, and any combinations thereof. In some aspects, at least one of the rubbery blocks R or each of the rubbery blocks R of the multi-arm block copolymer having the formula Qₙ-Y comprises polyisoprene but not polybutadiene.

Suitable glassy blocks G for use in the multi-arm block copolymer having the formula Qₙ-Y herein comprise a polymerized monovinyl aromatic monomer. In some aspects, the monovinyl aromatic monomer has 8 to 18 carbon atoms. Examples of suitable monovinyl aromatic monomers include styrene, vinylpyridine, substituted styrenes (e.g., vinyl toluene, alpha-methyl styrene, methyl styrene, dimethylstyrene, ethylstyrene, diethyl styrene, t-butylstyrene, di-n-butylstyrene, isopropylstyrene, and other alkylated-styrenes), styrene analogs, and styrene homologs. In some aspects, the glassy block G of at least one arm comprises a monovinyl aromatic monomer selected from the group consisting of styrene, alkylated styrenes, and any combinations thereof. According to an advantageous aspect, the glassy blocks G of each arm comprise a monovinyl aromatic monomer selected from the group consisting of styrene, styrene-compatible blends, and any combinations thereof.

For some aspects of the multilayer pressure sensitive adhesive assembly according to the present disclosure, at least one arm of the multi-arm block copolymer having the formula Qₙ-Y is selected from the group consisting of styrene-isoprene-styrene, styrene-butadiene-styrene, styrene-ethylene-butylene-styrene, styrene-ethylene-propylene-styrene, and combinations thereof. For some aspects, each arm of the multi-arm block copolymer having the formula Qₙ-Y is selected from the group consisting of styrene-isoprene-styrene, styrene-butadiene-styrene, styrene-ethylene-butylene-styrene, styrene-ethylene-propylene-styrene, and any combinations thereof. For some aspects, each arm of the multi-arm block copolymer having the formula Qₙ-Y is selected from the group consisting of styrene-isoprene-styrene, styrene-butadiene-styrene, and any combinations thereof. For some aspects, at least one arm or each arm of the multi-arm block copolymer having the formula Qₙ-Y is a styrene-isoprene-styrene polymer.

For some aspects, the multi-arm block copolymer having the formula Qₙ-Y for use herein is a (multi-arm) star block copolymer. For some aspects, the multi-arm block copolymer having the formula Qₙ-Y is a polymodal block copolymer. As used herein, the term “polymodal” means that the copolymer comprises endblocks having at least two different molecular weights. Such a block copolymer may also be characterized as having at least one “high” molecular weight endblock, and at least one “low” molecular weight endblock, wherein the terms high and low are used relative to each other. In some particular aspects, the ratio of the number average molecular weight of the high molecular weight endblock, (Mn)H, relative to the number average molecular weight of the low molecular weight endblock, (Mn)L, is at least about 1.25.

In some aspects, (Mn)H ranges from about 5000 to about 50000. In some aspects, (Mn)H is at least about 8000, and in some aspects at least about 10000. In some aspects, (Mn)H is no greater than about 35000. In some aspects, (Mn)L ranges from about 1000 to about 10000. In some aspects, (Mn)L is at least about 2000, and, in some aspects, at least about 4000. In some aspects, (Mn)L is less than about 9000, and, in some aspects, less than about 8000.

According to some aspects, the multi-arm block copolymer having the formula Qₙ-Y is an asymmetric block copolymer. In some aspects, the multi-arm block copolymer is a polymodal, asymmetric block copolymer.

Generally, the multifunctional coupling agent Y for use herein may be any polyalkenyl coupling agent or other material known to have functional groups that can react with carbanions of the living polymer to form linked polymers. The polyalkenyl coupling agent may be aliphatic, aromatic, or heterocyclic. Examples of aliphatic polyalkenyl coupling agents include polyvinyl and polyalkyl acetylenes, diacetylenes, phosphates, phosphites, and dimethacrylates (e.g., ethylene dimethacrylate). Examples of aromatic polyalkenyl coupling agents include polyvinyl benzene, polyvinyl toluene, polyvinyl xylene, polyvinyl anthracene, polyvinyl naphthalene, and divinyldurene. Examples of polyvinyl groups include divinyl, trivinyl, and tetravinyl groups. In some aspects, divinylbenzene (DVB) may be used, and may include o-divinyl benzene, m-divinyl benzene, p-divinyl benzene, and mixtures thereof. Examples of heterocyclic polyalkenyl coupling agents include divinyl pyridine, and divinyl thiophene. Other examples of multifunctional coupling agents include silicon halides, polyepoxides, polyisocyanates, polyketones, polyanhydrides, and dicarboxylic acid esters.

The multi-arm block copolymer having the formula Qₙ-Y as described above is present in an amount greater than 20 wt %, based on the total weight of the first pressure sensitive adhesive layer. In some aspects, the amount of multi-arm block copolymer having the formula Qₙ-Y can be, for example, in the range from 21 wt % to 65 wt %, from 25 wt % to 60 wt %, from 21 wt % to 40 wt %, or from 25 wt % to 35 wt %, based on the total weight of the first pressure sensitive adhesive layer.

In some aspects, the first pressure sensitive adhesive layer in the assemblies and methods disclosed herein comprises a linear block copolymer of the formula L-(G)ₘ, wherein L represents a rubbery block, G represents a glassy block, and m, the number of glassy blocks, is 1 or 2. Suitable rubbery blocks L include a polymerized olefin, a polymerized conjugated diene, a hydrogenated derivative of a polymerized conjugated diene, and any combinations thereof.

In some aspects, m is one, and the linear block copolymer of the formula L-(G)ₘ is a diblock copolymer comprising one rubbery block L and one glassy block G. In some aspects, m is two, and the linear block copolymer comprises two glassy endblocks and one rubbery midblock, i.e., the linear block copolymer of the formula L-(G)ₘ is a triblock copolymer. In some aspects, the linear block copolymer of the formula L-(G)ₘ comprises both a triblock copolymer and a diblock copolymer.

In some aspects, the rubbery block L comprises a polymerized conjugated diene, a hydrogenated derivative of a polymerized conjugated diene, or any combinations thereof. In some aspects, the conjugated diene has 4 to 12 carbon atoms. Examples of suitable conjugated dienes include butadiene, isoprene, ethylbutadiene, phenylbutadiene, piperylene, pentadiene, hexadiene, ethylhexadiene, and dimethylbutadiene. The polymerized conjugated dienes may be used individually or as copolymers with each other. In some aspects, the rubbery block L of the linear block copolymer of the formula L-(G)ₘ comprises a polymerized conjugated diene selected from the group consisting of isoprene, butadiene, and any combinations thereof. In some aspects, the rubbery block L of the linear block copolymer of the formula L-(G)ₘ comprises polyisoprene but not polybutadiene. In some aspects, the rubbery block L comprises a polymerized olefin, such as isobutylene.

In some aspects, at least one glassy block G comprises a polymerized monovinyl aromatic monomer. In some aspects, both glassy blocks of a triblock copolymer comprise a polymerized monovinyl aromatic monomer. In some aspects, the linear block copolymer of the formula L-(G)ₘ comprises two glassy blocks. In some aspects, the monovinyl aromatic monomer has 8 to 18 carbon atoms. Examples of suitable monovinyl aromatic monomers include styrene, vinylpyridine, substituted styrenes (e.g., vinyl toluene, alpha-methyl styrene, methyl styrene, dimethylstyrene, ethylstyrene, diethyl styrene, t-butylstyrene, di-n-butylstyrene, isopropylstyrene, and other alkylated-styrenes), styrene analogs, and styrene homologs. In some aspects, the monovinyl aromatic monomer is selected from the group consisting of styrene, alkylated styrenes, and any combinations thereof.

In some aspects, the linear block copolymer of the formula L-(G)ₘ comprises a diblock copolymer. In some aspects, the diblock copolymer is selected from the group consisting of styrene-isoprene and styrene-butadiene. In some aspects, the linear block copolymer of the formula L-(G)ₘ comprises a triblock copolymer. In some aspects, the triblock copolymer is selected from the group consisting of styrene-isoprene-styrene, styrene-butadiene-styrene, styrene-ethylene-butylene-styrene, styrene-ethylene-propylene-styrene, styrene-isobutylene-styrene, and any combinations thereof. Diblock and triblock copolymers are commercially available, e.g., under the trade name VECTOR available from Dexco Polymer LP, Houston, Texas and under the trade name KRATON available from Kraton Polymers U.S. LLC, Houston, Texas. As manufactured and/or purchased, triblock copolymers may contain some fraction of diblock copolymer as well.

In some aspects, the amount of the linear block copolymer having the formula L-(G)ₘ in the first pressure sensitive adhesive layer is in a range from 0 wt % to 35 wt %, from 5 wt % and 35 wt %, from 10 wt % to 35 wt %, or from 15 wt % and 30 wt %, based on the total weight of the first pressure sensitive adhesive layer. In some aspects, the amount of diblock copolymer, in which m is 1, in the linear block copolymer is in a range from 0 wt % and 25 wt %, from 0 wt % and 20 wt %, from 2 wt % and 20 wt %, or from 5 wt % and 20 wt %, based on the weight of the linear block copolymer.

In some aspects when the linear block copolymer having the formula L-(G)ₘ is present in the first pressure sensitive adhesive layer, the weight ratio of the multi-arm block copolymer having the formula Qₙ-Y to the linear block copolymer having the formula L-(G)ₘ is in a range from 1:1 to 5:1, 1:1 to 4:1, 1:1 to 3:1, or 1:1 to 2:1. Such high ratios of the multi-arm block copolymer having the formula Qₙ-Y to the linear block copolymer L-(G)ₘ can provide advantageous adhesion performance of the multilayer pressure sensitive adhesive assembly on critical substrates, in particular the high temperature shear adhesion performance of the multilayer pressure sensitive adhesive assembly. The presence of the diblock copolymer L-(G)ₘ may provide various beneficial effects to the (co)polymeric precursor of the first pressure sensitive adhesive and to the resulting multilayer pressure sensitive adhesive assembly. In particular, the addition of a diblock copolymer as described above may advantageously impact the processability of the (co)polymeric precursor of the first pressure sensitive adhesive due to the viscosity lowering effect (rheology modifier) of this compound. Furthermore, it has been surprisingly found that the diblock copolymer as described above, when present in the first pressure sensitive adhesive, does not unwantedly migrate into other layers of the multilayer pressure sensitive adhesive assembly according to the present disclosure, whilst still providing a plasticizing effect to the (co)polymeric precursor of the first pressure sensitive adhesive.

According to the present disclosure, the first pressure sensitive adhesive layer further comprises at least one hydrocarbon tackifier. Hydrocarbon tackifiers typically included in conventional pressure-sensitive adhesive compositions may be used in the context of the present disclosure. Useful hydrocarbon tackifiers are typically selected to be miscible with the copolymeric material and to have a VOC value of less than 1000 ppm, when measured by thermogravimetric analysis according to the test method described in U.S. Pat. Appl. Pub. No. 2019/0345367 (Eckhardt et al.), a Volatile Fogging Compound (FOG) value of less than 1500 ppm, when measured by thermogravimetric analysis according to the test method described in U.S. Pat. Appl. Pub. No. 2019/0345367 (Eckhardt et al.), and/or an outgassing value of less than 1 wt %, when measured by weight loss analysis as described in U.S. Pat. Appl. Pub. No. 2019/0345367 (Eckhardt et al.). Suitable hydrocarbon tackifier(s) for use herein may be easily identified by those skilled in the art, in the light of the present disclosure.

Either solid or liquid hydrocarbon tackifiers may be added. Solid tackifiers generally have a number average molecular weight (Mₙ) of 10,000 grams per mole or less and a softening point above about 70° C. Liquid tackifiers are viscous materials that have a softening point of about 0° C. to about 20° C. In some aspects, the hydrocarbon tackifier is a solid tackifier.

Suitable hydrocarbon tackifiers include terpene resins such as polyterpenes (e.g., alpha pinene-based resins, beta pinene-based resins, and limonene-based resins) and aromatic-modified polyterpene resins (e.g., phenol modified polyterpene resins); coumarone-indene resins; and petroleum-based hydrocarbon resins such as C5-based hydrocarbon resins, C9-based hydrocarbon resins, C5/C9-based hydrocarbon resins, and dicyclopentadiene-based resins. Any of these hydrocarbon tackifiers can be partially or fully hydrogenated to improve their color, their thermal stability, and/or their process compatibility. Combinations of various hydrocarbon tackifiers can be used if desired.

Tackifiers that are hydrocarbon resins can be prepared from various petroleum-based feed stocks. These feedstocks can be aliphatic hydrocarbons (mainly C5 monomers with some other monomers present such as a mixture of trans-1,3-pentadiene, cis-1,3-pentadiene, 2-methyl-2-butene, dicyclopentadiene, cyclopentadiene, and cyclopentene), aromatic hydrocarbons (mainly C9 monomers with some other monomers present such as a mixture of vinyl toluenes, dicyclopentadiene, indene, methylstyrene, styrene, and methylindenes), or mixtures thereof. Hydrocarbon tackifiers derived from C5 monomers are referred to as C5-based hydrocarbon resins while those derived from C9 monomers are referred to as C9-based hydrocarbon resins. Some tackifiers are derived from a mixture of C5 and C9 monomers or are a blend of C5-based hydrocarbon tackifiers and C9-based hydrocarbon tackifiers. These tackifiers can be referred to as C5/C9-based hydrocarbon tackifiers.

The C5-based hydrocarbon tackifiers are commercially available from Eastman Chemical Company under the trade designations PICCOTAC and EASTOTAC, from Cray Valley under the trade designation WINGTACK, from Neville Chemical Company under the trade designation NEVTAC LX, and from Kolon Industries, Inc. under the trade designation HIKOREZ. The C5-based hydrocarbon tackifiers are commercially available from Eastman Chemical with various degrees of hydrogenation under the trade designation EASTOTACK.

The C9-based hydrocarbon tackifiers are commercially available from Eastman Chemical Company under the trade designation PICCO, KRISTLEX, PLASTOLYN, and PICCOTAC, and ENDEX, from Cray Valley under the trade designations NORSOLENE, from Ruetgers N.V. under the trade designation NOVAREZ, and from Kolon Industries, Inc. under the trade designation HIKOTAC. These resins can be partially or fully hydrogenated. Prior to hydrogenation, the C9-based hydrocarbon resins are often about 40 percent aromatic as measured by proton Nuclear Magnetic Resonance. Hydrogenated C9-based hydrocarbon resins are commercially available, for example, from Eastman Chemical under the trade designations REGALITE and REGALREZ that are 50 to 100 percent (e.g., 50 percent, 70 percent, 90 percent, and 100 percent) hydrogenated. The partially hydrogenated resins typically have some aromatic rings.

Various C5/C9-based hydrocarbon tackifiers are commercially available from Arakawa under the trade designation ARKON, from Zeon under the trade designation QUINTONE, from Exxon Mobil Chemical under the trade designation ESCOREZ, and from Newport Industries under the trade designations NURES and H-REZ (Newport Industries). In the context of the present disclosure, suitable hydrocarbon tackifiers for use herein may be advantageously selected among those C5/C9-based hydrocarbon tackifiers commercially available from Exxon Mobil Chemical under the trade designation ESCOREZ.

In some aspects of the multilayer pressure sensitive adhesive assembly of the present disclosure, the hydrocarbon tackifier is selected from the group consisting of aliphatic hydrocarbon resins, cycloaliphatic hydrocarbon resins, aromatic modified aliphatic and cycloaliphatic resins, aromatic resins, hydrogenated hydrocarbon resins, terpene and modified terpene resins, terpene-phenol resins, rosin esters, and any combinations or mixtures thereof.

In some aspects of the present disclosure, the tackifying resin is selected from the group consisting of C5-based hydrocarbon resins, C9-based hydrocarbon resins, C5/C9-based hydrocarbon resins, and any combinations or mixtures thereof. In some aspects, the tackifying resin is selected from the group consisting of hydrogenated terpene resins, hydrogenated rosin resins, hydrogenated C5-based hydrocarbon resins, hydrogenated C9-based hydrocarbon resins, hydrogenated C5/C9-based hydrocarbon resins, and any combinations or mixtures thereof.

In some aspects, the hydrocarbon tackifier is compatible with at least some of the rubbery blocks R and optionally, the rubbery blocks L. In some aspects, the hydrocarbon tackifier is compatible with at least each rubbery block R of a multi-arm block copolymer having the formula Qₙ-Y and optionally with the rubbery blocks L of the linear block copolymer having the formula L-(G)ₘ.

As used herein, a tackifier is “compatible” with a block if it is miscible with that block. Generally, the miscibility of a tackifier with a block can be determined by measuring the effect of the tackifier on the Tg of that block. If a tackifier is miscible with a block, it will alter (e.g., increase) the Tg of that block. A tackifier is “compatible” with a block if it is at least miscible with that block, although it may also be miscible with other blocks. For example, a tackifier that is compatible with at least a rubbery block will be miscible with the rubbery block but may also be miscible with a glassy block.

Examples of hydrocarbon tackifiers that are compatible with at least the rubbery blocks R and optionally, the rubbery blocks L are advantageously selected from the group consisting of polymeric terpenes, hetero-functional terpenes, coumarone-indene resins, rosin acids, esters of rosin acids, disproportionated rosin acid esters, hydrogenated C5 aliphatic resins, C9 hydrogenated aromatic resins, C5/C9 aliphatic/aromatic resins, dicyclopentadiene resins, hydrogenated hydrocarbon resins arising from C5/C9 and dicyclopentadiene precursors, hydrogenated styrene monomer resins, and any blends thereof.

In the context of the present disclosure, it has been found that the addition of a hydrocarbon tackifier which is compatible with at least the rubbery blocks, advantageously impacts the adhesion performance (in particular, peel performance).

In some aspects, the hydrocarbon tackifier for use in the first pressure sensitive adhesive layer has a Tg of at least 60° C., at least 65° C. or even at least 70° C. In some aspects, the hydrocarbon tackifier has a softening point of at least about 115° C. or at least about 120° C.

In some aspects, suitable hydrocarbon tackifiers for use in the first pressure sensitive adhesive layer are selected from those having a VOC value of less than 1000 ppm, less than 800 ppm, less than 600 ppm, less than 400 ppm, or less than 200 ppm, when measured by thermogravimetric analysis according to the test method described in U.S. Pat. Appl. Pub. No. 2019/0345367 (Eckhardt et al.). In some aspects, the hydrocarbon tackifier for use in the first pressure sensitive adhesive layer has a FOG value of less than 1500 ppm, less than 1000 ppm, less than 800 ppm, less than 600 ppm, or less than 500 ppm, when measured by thermogravimetric analysis according to the test method described in U.S. Pat. Appl. Pub. No. 2019/0345367 (Eckhardt et al.). In some aspects, the hydrocarbon tackifier for use in the first pressure sensitive adhesive layer has an outgassing value of less than 1 wt %, less than 0.8 wt %, less than 0.6 wt %, less than 0.5 wt %, less than 0.4 wt %, less than 0.3 wt %, less than 0.2 wt %, or less than 0.1 wt %, when measured by weight loss analysis according to the oven outgassing test method described in U.S. Pat. Appl. Pub. No. 2019/0345367 (Eckhardt et al.).

In some aspects, the hydrocarbon tackifier(s) for use herein are advantageously selected from the group consisting of coumarone-indene resins, rosin acids, esters of rosin acids, disproportionated rosin acid esters, C9 aromatics, styrene, alpha-methyl styrene, pure monomer resins and C9/C5 aromatic-modified aliphatic hydrocarbons, and blends thereof.

In some aspects of the first pressure sensitive adhesive layer for use in the present disclosure, the ratio of the total weight of all block copolymers to the total weight of all hydrocarbon tackifiers ranges from 2.4:1 to 1:2.4, from 2:1 to 1:2, from 1.5:1 to 1:1.5, from 1.2:1 to 1:1.2, from 1.15:1 to 1:1.15, or from 1.1:1 to 1:1.1. In some aspects of the first pressure sensitive adhesive layer, the hydrocarbon tackifier(s) may be used in amounts of up to 60 wt %, based on the total weight of the first pressure sensitive adhesive layer. In some aspects, the hydrocarbon tackifiers can be used in amounts up to 55 wt % or up to 50 wt %, based on the total weight of the first pressure sensitive adhesive layer. The amount of hydrocarbon tackifiers can be for example, in the range of from 35 wt % to 60 wt %, from 40 wt % to 60 wt %, or from 40 wt % to 55 wt %, based on the total weight of the first pressure sensitive adhesive layer.

In some aspects, the first pressure sensitive adhesive layer for use herein is substantially free of a (meth)acrylate copolymer having a Tg higher than 25° C., 30° C., 40° C., 50° C., 60° C., or 70° C. and a weight average molecular weight (Mw) between 1000 and 100,000 Daltons, as determined by conventional gel permeation chromatography GPC, and comprising one or more (meth)acrylic acid ester monomer units having a Tg higher than 25° C., 30° C., 40° C., 50° C., 60° C., or 70° C. when homopolymerized. When substantially free of such (meth)acrylate copolymers in the first pressure sensitive adhesive layer, the multilayer pressure sensitive adhesive assembly advantageously can have lower odor as measured by VDA270 C3.

In the context of the present disclosure, and for determining the Tg of the (meth)acrylate copolymer for use herein, a useful predictor of interpolymer Tg for specific combinations of various monomers can be computed by application of Fox Equation: 1/Tg=ΣWᵢ/Tgᵢ. In this equation, Tg is the glass transition temperature of the mixture, Wᵢ is the weight fraction of component i in the mixture, and Tgᵢ is the glass transition temperature of component i, and all glass transition temperatures are in Kelvin (K). Some (meth)acrylic acid ester monomer units in (meth)acrylate copolymer having a Tg higher than 25° C. are isobornyl (meth)acrylate, tert-butyl acrylate, methyl methacrylate, ethyl methacrylate, n-propyl methacrylate, isopropyl methacrylate, n-butyl methacrylate, isobutyl methacrylate, sec-butyl methacrylate, tert-butyl methacrylate, stearyl (meth)acrylate, phenyl (meth)acrylate, cyclohexyl (meth)acrylate, benzyl (meth)acrylate, 3,3,5 trimethylcyclohexyl (meth)acrylate, N-octyl (meth)acrylamide, and any combinations or mixtures thereof. (Meth)acrylate copolymers having a Tg higher than 25° C. may include methyl (meth)acrylate, ethyl (meth)acrylate, isopropyl (meth)acrylate, t-butyl (meth)acrylate, n-butyl (meth)acrylate, isobutyl (meth)acrylate, s-butyl (meth)acrylate, stearyl (meth)acrylate, phenyl (meth)acrylate, cyclohexyl (meth)acrylate, isooctyl (meth)acrylate, 2-ethylhexyl acrylate, isobornyl (meth)acrylate, benzyl (meth)acrylate, 3,3,5 trimethylcyclohexyl (meth)acrylate, cyclohexyl (meth)acrylate, N-octyl acrylamide, propyl (meth)acrylate. (Meth)acrylate copolymer having a Tg higher than 25° C. may also comprise at least one of acrylic acid, methacrylic acid, 2-carboxyethyl acrylate, itaconic acid, hydroxyalkyl acrylates, acrylamides and substituted acrylamides (e.g., N,N′ dimethyl acrylamide, N,N′ diethyl acrylamide), acrylamines and substituted acrylamines, butyl carbamoyl ethyl acrylate, and any combinations or mixtures thereof.

“Substantially free” of a (meth)acrylate copolymer having a Tg higher than 25° C. and a weight average molecular weight (Mw) between 1000 and 100,000 Daltons as described above refers to less than 3 wt %, 2 wt %, 1 wt %, or 0.5 wt % and includes 0 wt %, based on the total weight of the first pressure sensitive adhesive layer. In some aspects, the first pressure sensitive adhesive layer is substantially free of (meth)acrylate copolymers in general, including random or block copolymers.

In some aspects, the first pressure sensitive adhesive layer for use herein is substantially free of a polymeric plasticizer having a weight average molecular weight M_{w} from 10,000 to 100,000 g/mol. Such polymeric plasticizers may be polyisobutylenes, polyisoprenes, polybutadienes, amorphous polyolefins and copolymers thereof, silicones, polyacrylates, oligomeric polyurethanes, ethylene propylene copolymers, and any combinations or mixtures thereof. “Substantially free” of a polymeric plasticizer having a weight average molecular weight M_{w} from 10,000 to 100,000 g/mol as described above refers to less than 2 wt %, 1 wt %, 0.5 wt %, or 0.1 wt % and includes 0 wt %, based on the total weight of the first pressure sensitive adhesive layer.

In some aspects, the first pressure sensitive adhesive layer useful in the present disclosure may further comprise, as an optional ingredient, a filler material. Filler materials for use in the first pressure sensitive adhesive layer can be any of those as described above for use in the polymeric foam. However, in some aspects, the first pressure sensitive adhesive layer is free of any filler material selected from the group consisting of microspheres, expandable microspheres (e.g., pentane filled expandable microspheres), gaseous cavities, glass beads, glass microspheres, glass bubbles and any combinations or mixtures thereof.

In some aspects of the multilayer pressure sensitive adhesive assembly according to the present disclosure, the first pressure sensitive adhesive layer comprises:
the multi-arm block copolymer in an amount ranging from 25 percent by weight to 60 percent by weight, based on the total weight of the first pressure sensitive adhesive layer;
the tackifier in an amount of 40 percent by weight to 60 percent by weight, based on the total weight of the first pressure sensitive adhesive layer; and
the linear block copolymer having the formula L-(G)ₘ in an amount from 0 percent by weight to 35 percent by weight, based on the total weight of the first pressure sensitive adhesive layer.

In some aspects, the multilayer pressure sensitive adhesive assembly according to the present disclosure is obtained by melt co-extrusion, in particular hotmelt co-extrusion of the polymeric foam layer and the first pressure sensitive adhesive layer. Melt co-extrusion, in particular hotmelt co-extrusion of the polymeric foam layer and the first pressure sensitive adhesive layer, can provide outstanding robustness as well as excellent resistance to delamination, even at high temperatures such as 70° C. and even higher. Furthermore, the multilayer pressure sensitive adhesive assembly obtained by melt co-extrusion, in particular hotmelt co-extrusion, of the polymeric foam layer and the first pressure sensitive adhesive layer, is less susceptible to unwanted migration of compounds (in particular processing aid or plasticizer) through the layers of the multilayer pressure sensitive adhesive assembly according to the present disclosure, primarily because the use of processing aids per se is unnecessary when melt co-extrusion process is performed.

The multilayer pressure sensitive adhesive assembly of the present disclosure comprises a polymeric foam layer and a first pressure sensitive adhesive layer, as described above, adjacent to the polymeric foam layer. The multilayer pressure sensitive adhesive assembly according to the present disclosure may have a design or configuration of any suitable kind, depending on its ultimate application and the desired properties, and provided it comprises a first pressure sensitive adhesive layer as described above and a polymeric foam layer.

In some aspects, the multilayer pressure sensitive adhesive assembly of the present disclosure may take the form of a multilayer construction comprising more superimposed layers, e.g., the first pressure sensitive adhesive layer, the polymeric foam layer and adjacent layers such as further pressure sensitive adhesive layers and/or a backing layer. Such adhesive multilayer constructions or tapes may be advantageously used as dual-layer adhesive tapes to adhere two objects to one another. In that context, suitable polymeric foam layers or backing layers for use herein may or may not exhibit at least partial pressure sensitive adhesive characteristics.

In some aspects, the multilayer pressure sensitive adhesive assembly according to the present disclosure comprises a polymeric foam having a first major surface and a second major surface; and a first pressure sensitive adhesive layer as described above bonded to the first major surface of the polymeric foam layer.

In some aspects of the multilayer pressure sensitive adhesive assembly, the first pressure sensitive adhesive layer for use herein has a thickness of less than 1500 μm, less than 1000 μm, less than 800 μm, less than 600 μm, less than 400 μm, less than 200 μm, less than 150 μm, or less than 100 μm. In some aspects, the first pressure sensitive adhesive layer for use herein has a thickness in a range from 20 to 1500 μm, from 20 to 1000 μm, from 20 to 500 μm, from 30 to 400 μm, from 30 to 250 μm, from 40 to 200 μm, or from 50 to 150 μm. In some aspects, the polymeric foam layer for use herein has a thickness in a range from 100 to 6000 μm, from 200 to 4000 μm, from 400 to 3000 μm, from 500 to 2000 μm, or from 800 to 1500 μm. As will be apparent to those skilled in the art, in the light of the present description, the thickness of the polymeric foam layer will be dependent on the intended application.

The thickness of the various pressure sensitive adhesive layer(s) and other optional layer(s) in the pressure sensitive adhesive assembly may vary depending on the desired execution and associated properties. By way of example, the thickness can be independently chosen for each layer in a range from 25 μm to 6000 μm, from 40 μm to 3000 μm, from 50 μm to 3000 μm, from 50 μm to 2000 μm, or from 50 μm to 1500 μm.

In some aspects, the multilayer pressure sensitive adhesive assembly is a skin/core type multilayer pressure sensitive adhesive assembly, wherein the polymeric foam layer is the core layer of the multilayer pressure sensitive adhesive assembly and the first pressure sensitive adhesive layer is a skin layer of the multilayer pressure sensitive adhesive assembly. The first pressure sensitive adhesive layer may have a lower thickness compared to the polymeric foam/core layer. For example, the thickness of the pressure sensitive adhesive layer may be in the range from 20 μm to 250 μm or from 40 μm to 200 μm, whereas the thickness of the polymeric foam layer may be in the range from 100 μm to 6000 μm, from 400 μm to 3000 μm, or from 800 μm to 2000 μm. Without wishing to be bound by theory, it is believed that high peel adhesion can be caused by a stabilizing effect of a relatively thick polymeric foam layer compared to the first pressure sensitive adhesive layer.

In some aspects, the multilayer pressure sensitive adhesive assembly further comprises a second pressure sensitive adhesive skin layer bonded to the second major surface of the polymeric foam layer. Such a multilayer pressure sensitive adhesive assembly reflects a three-layer design, in which the polymeric foam layer is sandwiched between two pressure sensitive adhesive layers. This may be considered a skin/core/skin multilayer assembly. In some aspects of the multilayer pressure sensitive adhesive assembly, the first pressure sensitive adhesive layer and the second pressure sensitive adhesive layer are the same adhesive and comprise a pressure sensitive adhesive composition as described above. In some aspects, the first pressure sensitive adhesive layer and the second pressure sensitive adhesive layer each independently comprise a pressure sensitive adhesive composition as described above in any of its aspects.

Multilayer pressure sensitive adhesive assemblies comprising a polymeric foam layer can be advantageous when compared to single-layer pressure sensitive adhesives, in that adhesion (quick adhesion) can be adjusted by the formulation of the pressure sensitive adhesive layer(s) (also commonly referred to as the skin layer(s)), while other properties/requirements of the overall assembly such as application issues, deforming issues, and energy distribution may be addressed by appropriate formulation of the polymeric foam layer (also commonly referred to as the core layer).

In some aspects of the multilayer pressure sensitive adhesive assembly according to the disclosure, a primer layer may be interposed between the pressure sensitive adhesive layer(s) and the polymeric foam (or core) layer. In the context of the present disclosure, any primer compositions commonly known to those skilled in the art may be used. Finding appropriate primer compositions is well within the capabilities of those skilled in the art, in the light of the present disclosure. Useful primers for use herein are described, e.g., in U.S. Pat. No. 5,677,376 (Groves) and U.S. Pat. No. 5,605,964 (Groves).

In some aspects, the multilayer pressure sensitive adhesive assembly as described above, has a VOC value of less than 1500 ppm, less than 1200 ppm, less than 1000 ppm, less than 800 ppm, less than 600 ppm, less than 500 ppm, or even less than 400 ppm, when measured by thermal desorption analysis according to test method VDA278 (hermal Desorption Analysis of Organic Emissions for the Characterization of Non-Metallic Materials for Automobiles) from VDA, Association of the German Automobile Industry.

In some aspects, the multilayer pressure sensitive adhesive assembly has a FOG value of less than 4000 ppm, less than 3000 ppm, less than 2500 ppm, less than 2000 ppm, less than 1500 ppm, less than 1000 ppm, less than 800 ppm, or even less than 600 ppm, when measured by thermal desorption analysis according to test method VDA278.

In some aspects, the multilayer pressure sensitive adhesive assembly has a static shear strength value of more than 300 min, more than 500 min, more than 1000 min, more than 2000 min, more than 4000 min, more than 5000 min, more than 6000 min, more than 8000 min, or more than 10000 min, when measured at 70° C. (500 g on stainless steel) according to the static shear test method described in the experimental section.

In some aspects, the multilayer pressure sensitive adhesive assembly has a static shear strength value of more than 300 min, more than 500 min, more than 1000 min, more than 2000 min, more than 4000 min, more than 5000 min, more than 6000 min, more than 8000 min, or more than 10000 min, when measured at 90° C. (500 g on stainless steel) according to the static shear test method described in the experimental section.

In some aspects, the multilayer pressure sensitive adhesive assembly has a peel strength value of more than 30 N/10 mm, more than 35 N/10 mm, more than 40 N/10 mm, more than 45 N/10 mm, or more than 50 N/10 mm, when measured at 23° C. on stainless steel according to the peel test method described in the experimental section.

In some aspects, the multilayer pressure sensitive adhesive assembly has a peel strength value of more than 30 N/10 mm, more than 35 N/10 mm, more than 40 N/10 mm, or more than 45 N/10 mm, when measured at 23° C. on polypropylene according to the peel test method described in the experimental section.

In some aspects, the multilayer pressure sensitive adhesive assembly has an odor level of not more than 4 or not more than 3 according to VDA270 C3.

Melt co-extrusion, in particular hotmelt co-extrusion, are techniques well known to those skilled in the art. Examples of hotmelt co-extrusion processes are described, e.g., in US 2003/0082362 A1 (Khandpur et al.), in US 2004/0082700 A1 (Khandpur et al.). Hotmelt co-extrusion typically involves forming a hotmelt composition, generally a polymer or blended polymeric material with a melt viscosity profile such that it can be extrusion coated on a substrate or carrier in a thin layer at a process temperature significantly above normal room temperature but can retain useful pressure-sensitive adhesive characteristics at room temperature.

A multilayer pressure sensitive adhesive assembly of the present disclosure may be manufactured by hotmelt co-extrusion of the polymeric foam layer, the first pressure sensitive adhesive layer, and optionally, the second pressure sensitive adhesive layer. Useful processes may involve compounding the various ingredients of each layer (e.g., block copolymer(s) and hydrocarbon tackifiers) to a hotmelt compound. Compounding can be performed in roll milling or in an extruder (such as single screw, twin screw, planetary, ring, disk screw, reciprocating single screw, and pin barrel single screw extruders). Commercially available equipment such as kneaders or mixers may also be used to compound batches of the pressure sensitive adhesive and polymer foam compositions. After compounding, the various prepared compositions are coextruded through a coextrusion die into a desired multilayer assembly. The processing of the multilayer extrudate is continued through a calendar or another type of coating equipment. Because of the tacky behavior of the at least the pressure sensitive adhesive composition, it is coated on a liner and the rolls are coated with materials which do not stick to the extruded adhesive.

In some aspects, the multilayer pressure sensitive adhesive assembly according to the present disclosure is crosslinked, for example, with actinic radiation such as e-beam irradiation. In some aspects, the multilayer pressure sensitive adhesive assembly is crosslinked with e-beam irradiation, wherein the e-beam irradiation dose is in a range from 50 kGy to 150 kGy. In some aspects, the e-beam irradiation is performed from both sides so as to achieve a symmetric irradiation profile within the multilayer pressure sensitive adhesive assembly. The step of crosslinking the multilayer pressure sensitive adhesive assembly as described above, in particular with actinic radiation, for example, with e-beam irradiation, can provide a multilayer pressure sensitive adhesive assembly characterized with excellent static shear performance both at room temperature and high temperature (e.g., 70° C.).

While performing e-beam irradiation-based crosslinking, finding a suitable e-beam irradiation dose in conjunction with selecting a suitable e-beam acceleration tension will be well within the practice of those skilled in the art. Suitable acceleration tensions are typically selected and adapted to the coating weight of the corresponding multilayer pressure sensitive adhesive assembly. E-beam acceleration voltages are typically in a range from 140 to 300 kV for pressure sensitive adhesive layers with a coating weight in a range from 25 and 1200 g/m². When irradiated from both sides, the pressure sensitive adhesive layers may have a coating weight up to 1800 g/m².

The actinic radiation crosslinking step may be applied under closed face (CF) or open face (OF) conditions. According to the “closed face” irradiation method, one or both faces of the hotmelt co-extruded multilayer pressure sensitive adhesive assembly are covered with a liner and the irradiation dose is applied through the liner(s). According to the “open face” irradiation method, one or both faces of the hotmelt co-extruded multilayer pressure sensitive adhesive assembly are exposed (i.e., not covered with a liner), and the irradiation dose is applied directly on the exposed adhesive surface(s).

Typically, the hotmelt co-extruded multilayer pressure sensitive adhesive assembly is deposited on a substrate and then crosslinked with actinic radiation, for example, e-beam radiation.

In another aspect of the present disclosure, a method for manufacturing a multilayer pressure sensitive adhesive assembly as described above is provided, which comprises the step of melt co-extruding, in particular hotmelt co-extruding the polymeric foam layer, the first pressure sensitive adhesive layer, and optionally, the second pressure sensitive adhesive layer.

In some aspects, the present disclosure is directed to a process for manufacturing a multilayer pressure sensitive adhesive assembly as described above. The process comprises compounding the multi-arm block copolymer and the at least one hydrocarbon tackifier to form a pressure sensitive adhesive formulation, melt co-extruding the polymeric foam layer and the pressure sensitive adhesive formulation to form the multilayer pressure sensitive adhesive assembly, and optionally crosslinking the multilayer pressure sensitive adhesive assembly with electron beam irradiation.

According to some aspects of the process for manufacturing a multilayer pressure sensitive adhesive assembly, the hotmelt of the polymeric foam layer comprises a filler material selected from the group consisting of expandable microspheres, expanded microspheres, glass bubbles, any combinations or mixtures thereof. According to this aspect, the method of manufacturing a multilayer pressure sensitive adhesive assembly may optionally comprise the step of allowing the expandable microspheres to expand or further expand.

In some aspects, the method of manufacturing a multilayer pressure sensitive adhesive assembly comprises an extrusion processing selected from the group consisting of multi screw extrusion processing, planetary extrusion processing, and any combinations thereof. According to some aspects, the process for manufacturing a multilayer pressure sensitive adhesive assembly comprises twin screw hotmelt extrusion processing.

According to some aspects of the process for manufacturing a multilayer pressure sensitive adhesive assembly, the hydrocarbon tackifier(s) are exposed to minimal heat stress before their feeding into the compounding medium. In the context of the present disclosure, it has been indeed found that heat stress at elevated temperatures applied to the hydrocarbon tackifier(s) for a long period of time may lead to an accelerated thermal and/or oxidative degradation of these ingredients and to the generation of VOCs.

Accordingly, in some aspects of the process for manufacturing a multilayer pressure sensitive adhesive assembly, the hydrocarbon tackifier(s) are added into the compounding medium with a drum unloader as feeding equipment. In some aspects, the hydrocarbon tackifier(s) are fed into the compounding medium with a single screw feeding extruder. In some aspects, the hydrocarbon tackifier(s) are fed to the compounding medium with kneading equipment having a discharge screw. In some aspects, the hydrocarbon tackifier(s) are added into the compounding medium in a solid state by means of volumetric or gravimetric feeders.

In some aspects, the process for manufacturing a multilayer pressure sensitive adhesive assembly comprises applying a vacuum degassing operation, such as a multi-stage vacuum degassing operation, of at least one of the hotmelt compound(s). Vacuum may be typically applied to the compounded adhesive melt during the extrusion process. Vacuum can be applied to the skin compound melt and/or to the core compound melt before adding the foaming agent.

According to some aspects, the process for manufacturing a multilayer pressure sensitive adhesive assembly comprises incorporating a VOC entraining additive, into at least one of the hotmelt compound(s), wherein the entraining additive is advantageously selected from the group consisting of water, carbon dioxide, nitrogen gas, and any combinations thereof.

According to some aspects of the process for manufacturing a multilayer pressure sensitive adhesive assembly, a chemical entrainer is added to the compounded adhesive melt and removed later in the extrusion process. Suitable entrainers for use herein are liquids, gases, or compounds that release a volatile chemical substance under the action of heat. Advantageously, the entrainer is capable of entraining further volatiles or last traces of volatiles. Suitable entrainers can be added to the skin PSA melt and or to the core melt and removed later in the extrusion process. In case the entrainer is added to the core compound, the latter is desirably removed before adding the foaming agent. One particularly suitable entraining additive for use herein is described in EP2808371-A1 (Buettner et al.).

In the context of manufacturing a multilayer pressure sensitive adhesive assembly, the various layers of the multilayer pressure sensitive adhesive assembly can be prepared as part of a single process step.

The multilayer pressure sensitive adhesive assembly of the present disclosure can be coated/applied upon a variety of substrates to produce adhesive-coated articles. The substrates can be flexible or inflexible and be formed of a polymeric material, paper, glass or ceramic material, metal, or combinations thereof. Suitable polymeric substrates include polymeric films such as those prepared from polypropylene, polyethylene, polyvinyl chloride, polyester (polyethylene terephthalate or polyethylene naphthalate), polycarbonate, polyurethane, polymethyl(meth)acrylate (PMMA), polyurethane acrylates, cellulose acetate, cellulose triacetate, ethyl cellulose, nonwovens (e.g., papers, cloths, nonwoven scrims), and metal foils. Foam backings may be used. Examples of other substrates include metal such as stainless steel, metal or metal oxide coated polymeric material, and metal or metal oxide coated glass.

The multilayer pressure sensitive adhesive assemblies of the present disclosure may be used in any conventionally known article such as labels, tapes, signs, covers, marking indices, display components, and touch panels. Flexible backing materials having microreplicated surfaces are also contemplated. The substrate to which the multilayer pressure sensitive adhesive assembly may be applied is selected depending on the particular application. For example, the multilayer pressure sensitive adhesive assembly may be applied to sheeting products (e.g., decorative graphics and reflective products), label stock, and tape backings. Additionally, the multilayer pressure sensitive adhesive assembly may be applied directly onto other substrates such as a metal panel (e.g., automotive panel) or a glass window so that yet another substrate or object can be attached to the panel or window. Accordingly, the multilayer pressure sensitive adhesive assembly of the present disclosure may find a particular use in the automotive manufacturing industry (e.g., for attachment of exterior trim parts or for weatherstrips), in the construction industry, in the solar panel construction industry, and in the electronic industry (e.g., for the fixation of displays in mobile hand held devices).

As such, the multilayer pressure sensitive adhesive assemblies according to the present disclosure are particularly suited for (industrial) interior applications, more in particular for construction market applications, automotive applications, and electronic applications. In the context of automotive applications, the multilayer pressure sensitive adhesive assemblies as described herein may find particular use for adhering, e.g., automotive body side mouldings, weather strips, and rearview mirrors. The multilayer pressure sensitive adhesive assemblies according to the present disclosure are particularly suitable for adhesion to substrates/panels painted with automotive paint systems comprising a base electrocoat or a pigmented basecoat, and in particular to clear coat surfaces, in particular clear coats for automotive vehicles. The multilayer pressure sensitive adhesive assemblies according to the present disclosure are particularly suited for adhesion to low energy surfaces, such as polypropylene, polyethylene or copolymers thereof.

Accordingly, the present disclosure is further directed to the use of a multilayer pressure sensitive adhesive assembly as described above for industrial applications, for example, for interior (industrial) applications, construction market applications, automotive applications, and/or electronic applications.

In another aspect, the present disclosure is further directed to the use of a multilayer pressure sensitive adhesive assembly as described above for automotive applications, in particular for taped seal on body, taped seal on door, exterior and interior parts attachment, and weather-strip tape applications for the automotive industry. In some aspects, the multilayer pressure sensitive adhesive assembly has values below threshold according to JAMA:Jaso M902 test method.

In some aspects, the multilayer pressure sensitive adhesive assembly according to the present disclosure may be particularly useful for forming strong adhesive bonds to low surface energy (LSE) substrates. However, the use of these multilayer pressure sensitive adhesive assemblies is not limited to low surface energy substrates. The multilayer pressure sensitive adhesive assemblies may, in some aspects, surprisingly bond well to medium surface energy (MSE) substrates. Included among such materials are PA6, ABS, PC/ABS blends, PC, PVC, PA, PUR, TPE, POM, polystyrene, poly(methyl methacrylate) (PMMA), clear coat surfaces, in particular clear coats for vehicles like a car or coated surfaces for industrial applications and composite materials like fiber reinforced plastics.

Accordingly, the present disclosure is further directed, in some aspects, to the use of a multilayer pressure sensitive adhesive assembly as above described for the bonding to a low surface energy substrate and/or a medium surface energy substrate.

The multilayer pressure sensitive adhesive assembly may also be provided as a single coated or double coated tape in which the multilayer pressure sensitive adhesive assembly is disposed on a permanent backing. Backings can be made from plastics (e.g., polypropylene, including biaxially oriented polypropylene, vinyl, polyolefin such as polyethylene, polyurethanes, polyurethane acrylates, polyesters such as polyethylene terephthalate), nonwovens (e.g., papers, cloths, nonwoven scrims), metal foils, and foams (e.g., polyacrylic, polyethylene, polyurethane, neoprene). Polymeric foams are commercially available from various suppliers such as 3M Co., Voltek, Sekisui, and others.

Item 1 is a multilayer pressure sensitive adhesive assembly comprising a polymeric foam layer and a first pressure sensitive adhesive layer adjacent to the polymeric foam layer, wherein the polymeric foam comprises a plurality of activated carbon particles distributed therein, and wherein the first pressure sensitive adhesive comprises:
a multi-arm block copolymer in an amount greater than 20 percent by weight, based on the total weight of the first pressure sensitive adhesive layer, the multi-arm block copolymer having formula Qₙ-Y,
wherein:
   Q represents an arm of the multi-arm block copolymer and each arm independently has the formula G-R,
   n represents the number of arms and is a whole number of at least 3, and
   Y is the residue of a multifunctional coupling agent,
   wherein each R is a rubbery block comprising a polymerized conjugated diene, a hydrogenated derivative of a polymerized conjugated diene, or combinations thereof, and each G is a glassy block comprising a polymerized monovinyl aromatic monomer; and
at least one hydrocarbon tackifier.

Item 2 is the multilayer pressure sensitive adhesive assembly according to item 1, wherein the activated carbon particles have an individual specific surface area in a range from 100 m²/g to 2000 m²/g, from 200 m²/g to 1500 m²/g, from 500 m²/g to 1400 m²/g, from 600 m²/g to 1200 m²/g, or from 700 m²/g to 1000 m²/g, when measured according to the BET nitrogen absorption test method.

Item 3 is a multilayer pressure sensitive adhesive assembly according to item 1 or 2, wherein at least 75%, at least 80%, at least 85%, at least 90%, or at least 95% of the pores of the activated carbon particles have a pore width no greater than 2 nanometers.

Item 4 is a multilayer pressure sensitive adhesive assembly according to any one of items 1 to 3, wherein the amount of activated carbon particles in the polymeric foam is at least 0.1 wt %, at least 1 wt %, at least 3 wt %, at least 5 wt % or even at least 10 wt %, based on the weight of the polymeric foam.

Item 5 is a multilayer pressure sensitive adhesive assembly according to any one of items 1 to 4, wherein the amount of activated carbon particles in the polymeric foam is no greater than 25 wt %, no greater than 20 wt %, or no greater than 15%, based on the weight of the polymeric foam.

Item 6 is a multilayer pressure sensitive adhesive assembly according to any one of items 1 to 5, wherein the activated carbon particles are present in the polymeric foam in an amount in a range from 0.1 percent to 15 percent by weight, based on the total weight of the polymeric foam.

Item 7 is a multilayer pressure sensitive adhesive assembly according to any one of items 1 to 6, wherein the polymeric foam comprises a polymer base material comprising at least one of a polyacrylate, a polyurethane, a polyolefin, a polyamine, a polyamide, a polyester, a polyether, a polyisobutylene, a polystyrene, natural rubber, a rubber-based elastomeric material, a polyvinyl, or polyvinylpyrrolidone.

Item 8 is a multilayer pressure sensitive adhesive assembly according to any one of items 1 to 7, wherein the polymeric foam comprises a polymer base material selected from the group consisting of polyacrylates whose main monomer component comprises a linear or branched alkyl (meth)acrylate ester comprising from 1 to 32, from 1 to 20, or from 1 to 15 carbon atoms.

Item 9 is a multilayer pressure sensitive adhesive assembly according to item 8, wherein the polymer base material further comprises a comonomer selected from the group consisting of acrylic acid, methacrylic acid, itaconic acid, hydroxyalkyl acrylates, acrylamides and substituted acrylamides, acrylamines and substituted acrylamines and any combinations or mixtures thereof.

Item 10 is a multilayer pressure sensitive adhesive assembly according to item 8 or 9, wherein the polymeric foam comprises:
a) from 60 to 100 wt %, from 70 to 95 wt %, from 80 to 95 wt % or from 85 to 95 wt % monomer units of at least one (meth)acrylate ester having a linear or branched alkyl group having from 1 to 32, from 1 to 20, or from 1 to 15 carbon atoms, based on the weight of the polymeric foam;
b) from 0 to 40 wt %, from 5 to 30 wt %, from 5 to 20 wt % or from 5 to 15 wt %, of acrylic acid monomer unit(s), based on the weight of the polymeric foam; and
c) from 0 to 20 wt %, from 1 to 15 wt %, from 2 to 13 wt % or from 2 to 10 wt %, of expandable microspheres, such as pentane filled expandable microspheres, based on the weight of the polymeric foam.

Item 11 is a multilayer pressure sensitive adhesive assembly according to any one of items 1 to 10, wherein the polymeric foam comprises a polyacrylic prepared by irradiating a composition comprising:
a) from 60 to 100 wt %, from 70 to 95 wt %, from 80 to 95 wt % or from 85 to 95 wt % of at least one (meth)acrylate ester monomer having a linear or branched alkyl group having from 1 to 32, from 1 to 20, or from 1 to 15 carbon atoms, based on the weight of the polyacrylate;
b) from 0 to 40 wt %, from 5 to 30 wt %, from 5 to 20 wt % or from 5 to 15 wt %, of acrylic acid monomer(s), based on the weight of the polyacrylate; and
c) from 0.01 to about 5.0 parts, from 0.1 to 1.0 part, or from 0.1 to 0.5 part, per 100 parts by weight of total monomer of a multifunctional alpha-hydroxy ketone photoinitiator.

Item 12 is a multilayer pressure sensitive adhesive assembly according to any one of items 1 to 11, wherein the multi-arm block copolymer of the formula Qₙ-Y, is a star block copolymer.

Item 13 is a multilayer pressure sensitive adhesive assembly according to any one of items 1 to 12, wherein the polymerized conjugated diene comprises at least one of polyisoprene or polybutadiene, or wherein R further comprises polyisobutylene.

Item 14 is a multilayer pressure sensitive adhesive assembly according to any one of items 1 to 13, wherein for at least one of the rubbery blocks R of the multi-arm block copolymer having the formula Qₙ-Y, the polymerized conjugated diene comprises at least one of isoprene or butadiene; or wherein for each of the rubbery blocks R of the multi-arm block copolymer having the formula Qₙ-Y, the polymerized conjugated diene comprises at least one of isoprene or butadiene.

Item 15 is a multilayer pressure sensitive adhesive assembly according to any one of items 1 to 14, wherein at least one of the glassy blocks of the multi-arm block copolymer having the formula Qₙ-Y is a polymerized monovinyl aromatic monomer comprising at least one of styrene or an alkylated styrene; or wherein each of the glassy blocks of the multi-arm block copolymer having the formula Qₙ-Y is a polymerized monovinyl aromatic monomer comprising at least one of styrene or an alkylated styrene.

Item 16 is a multilayer pressure sensitive adhesive assembly according to any one of items 1 to 15, wherein at least one arm of the multi-arm block copolymer having the formula Qₙ-Y or wherein each arm of the multi-arm block copolymer having the formula Qₙ-Y is selected from the group consisting of styrene-isoprene-styrene, styrene-butadiene-styrene, styrene-ethylene-butylene-styrene, styrene-ethylene-propylene-styrene, and combinations thereof.

Item 17 is a multilayer pressure sensitive adhesive assembly according to any one of items 1 to 16, wherein the number of arms n of the multi-arm block copolymer having the formula Qₙ-Y, is a whole number from 3 to 5.

Item 18 is a multilayer pressure sensitive adhesive assembly according to any one of items 1 to 17, wherein the first pressure sensitive adhesive layer comprises:
the multi-arm block copolymer in an amount ranging from 25 percent by weight to 60 percent by weight, based on the total weight of the first pressure sensitive adhesive layer;
the tackifier in an amount of 40 percent by weight to 60 percent by weight, based on the total weight of the first pressure sensitive adhesive layer; and
a linear block copolymer having the formula L-(G)ₘ in an amount from 0 percent by weight to 35 percent by weight, based on the total weight of the first pressure sensitive adhesive layer, wherein:
   L is a rubbery block comprising a polymerized olefin, a polymerized conjugated diene, a hydrogenated derivative of a polymerized conjugated diene, or any combinations thereof; and
   G is a glassy block comprising a polymerized monovinyl aromatic monomer; and wherein m is 1 or 2.

Item 19 is a multilayer pressure sensitive adhesive assembly according to item 18, wherein the rubbery block L of the linear block copolymer having the formula L-(G)ₘ, comprises at least one of polyisobutylene, polyisoprene, or polybutadiene.

Item 20 is a multilayer pressure sensitive adhesive assembly according to item 18 or 19, wherein at least one glassy block G of the linear block copolymer having the formula L-(G)ₘ, comprises a polymerized mono vinyl aromatic monomer comprising at least one of styrene or an alkylated styrene.

Item 21 is a multilayer pressure sensitive adhesive assembly according to any one of items 18 to 20, wherein the linear block copolymer having the formula L-(G)ₘ, is selected from the group consisting of styrene-isoprene-styrene, styrene-butadiene-styrene, styrene-ethylene-butylene-styrene, styrene-isobutylene-styrene, styrene-ethylene-propylene-styrene, and any combinations thereof.

Item 22 is a multilayer pressure sensitive adhesive assembly according to any one of items 18 to 21, wherein a weight ratio of the multi-arm block copolymer to the linear block copolymer in the first pressure sensitive adhesive is in a range from 1:1 to 5.1.

Item 23 is a multilayer pressure sensitive adhesive assembly according to any one of items 1 to 22, wherein the hydrocarbon tackifier has a Tg of at least 60° C. or at least 65° C., and wherein the hydrocarbon tackifier is compatible with at least the rubbery blocks R and optionally the rubbery blocks L.

Item 24 is a multilayer pressure sensitive adhesive assembly according to any one of items 1 to 23, wherein the hydrocarbon tackifier is selected from the group consisting of coumarone-indene resins, rosin acids, esters of rosin acids, disproportionated rosin acid esters, C9 aromatics, styrene, alpha-methyl styrene, pure monomer resins and C9/C5 aromatic-modified aliphatic hydrocarbons, and blends thereof.

Item 25 is a multilayer pressure sensitive adhesive assembly according to any one of items 1 to 24, wherein the hydrocarbon tackifier has a Volatile Organic Compound (VOC) value of less than 800 ppm, less than 600 ppm, less than 400 ppm or less than 200 ppm, when measured by thermogravimetric analysis.

Item 26 is a multilayer pressure sensitive adhesive assembly according to any one of items 1 to 25, wherein the hydrocarbon tackifier has a Volatile Fogging Compound (FOG) value of less than 1500 ppm, less than 1000 ppm, less than 800 ppm, less than 600 ppm, or less than 500 ppm, when measured by thermogravimetric analysis.

Item 27 is a multilayer pressure sensitive adhesive assembly according to any one of items 1 to 26, wherein the hydrocarbon tackifier has an outgassing value of less than 1 wt %, less than 0.8 wt %, less than 0.6 wt %, less than 0.5 wt %, less than 0.4 wt %, less than 0.3 wt %, less than 0.2 wt % or less than 0.1 wt %, when measured by weight loss analysis according to the oven outgassing test method described in U.S. Pat. Appl. Pub. No. 2019/0345367.

Item 28 is a multilayer pressure sensitive adhesive assembly according to any one of items 1 to 27, wherein the ratio of the total weight of all block copolymers to the total weight of all hydrocarbon tackifiers in the first pressure sensitive adhesive ranges from 2.4:1 to 1:2.4, from 2:1 to 1:2, from 1.5:1 to 1:1.5, from 1.2:1 to 1:1.2, from 1.15:1 to 1:1.15, or from 1.1:1 to 1:1.1.

Item 29 is a multilayer pressure sensitive adhesive assembly according to any one of items 1 to 28, wherein the first pressure sensitive adhesive layer is substantially free of a (meth)acrylate copolymer having a Tg higher than 25° C., a weight average molecular weight (Mw) between 1000 and 100,000 grams/mole, and comprising (meth)acrylic acid ester monomer units having a Tg higher than 25° C. when homopolymerized.

Item 30 is a multilayer pressure sensitive adhesive assembly according to any one of items 1 to 29, wherein the first pressure sensitive adhesive layer is substantially free of (meth)acrylate copolymers.

Item 31 is a multilayer pressure sensitive adhesive assembly according to any one of items 1 to 30, wherein the first pressure sensitive adhesive layer is substantially free of a polymeric plasticizer having a weight average molecular weight M_{w} of at least 10,000 grams/mole.

Item 32 is a multilayer pressure sensitive adhesive assembly according to any one of items 1 to 31, which is obtained by melt co-extrusion, in particular hotmelt co-extrusion, of the polymeric foam layer and the first pressure sensitive adhesive layer.

Item 33 is a multilayer pressure sensitive adhesive assembly according to any one of items 1 to 32, which is crosslinked with actinic radiation or with e-beam irradiation.

Item 34 is a multilayer pressure sensitive adhesive assembly according to any one of items 1 to 33, wherein the polymeric foam layer has a first major surface and a second major surface, wherein the first pressure sensitive adhesive layer bonded to the first major surface of the polymeric foam layer, wherein the multilayer pressure sensitive adhesive assembly further comprises a second pressure sensitive adhesive layer bonded to the second major surface of the polymeric foam layer.

Item 35 is a multilayer pressure sensitive adhesive assembly according to item 34, wherein the first pressure sensitive adhesive layer and the second pressure sensitive adhesive layer have the same pressure sensitive adhesive composition.

Item 36 is a multilayer pressure sensitive adhesive assembly according to item 34, wherein the first pressure sensitive adhesive layer and the second pressure sensitive adhesive layer each independently comprise a pressure sensitive adhesive composition as described in any of items 1 to 32.

Item 37 is a multilayer pressure sensitive adhesive assembly according to any one of items 1 to 36, wherein the polymeric foam layer further comprises at least one filler material selected from the group consisting of microspheres; expandable microspheres, such as pentane filled expandable microspheres; expanded microspheres; gaseous cavities; glass beads; glass microspheres; glass bubbles and any combinations or mixtures thereof.

Item 38 is a multilayer pressure sensitive adhesive assembly according to item 37, wherein the at least one filler material is selected from the group consisting of expandable microspheres, glass bubbles, and any combinations or mixtures thereof.

Item 39 is a multilayer pressure sensitive adhesive assembly according to any one of items 1 to 38, which has a Volatile Organic Compound (VOC) value of less than 1500 ppm, less than 1200 ppm, less than 1000 ppm, less than 800 ppm, less than 600 ppm, less than 500 ppm, or less than 400 ppm, when measured by thermal desorption analysis according to test method VDA278.

Item 40 is a multilayer pressure sensitive adhesive assembly according to any one of items 1 to 39, which has a Volatile Fogging Compound (FOG) value of less than 4000 ppm, less than 3000 ppm, less than 2500 ppm, less than 2000 ppm, less than 1500 ppm, less than 1000 ppm, less than 800 ppm, or less than 600 ppm, when measured by thermal desorption analysis according to test method VDA278.

Item 41 is a multilayer pressure sensitive adhesive assembly according to any one of items 1 to 40, which has a static shear strength value of more than 300 min, more than 500 min, more than 1000 min, more than 2000 min, more than 4000 min, more than 5000 min, more than 6000 min, more than 8000 min, or more than 10000 min, when measured at 70° C. (500 g on polypropylene) according to the static shear test method described in the experimental section.

Item 42 is a multilayer pressure sensitive adhesive assembly according to any one of items 1 to 41, which has a static shear strength value of more than 300 min, more than 500 min, more than 1000 min, more than 2000 min, more than 4000 min, more than 5000 min, more than 6000 min, more than 8000 min, or more than 10000 min, when measured at 90° C. (500 g on stainless steel) according to the static shear test method described in the experimental section.

Item 43 is a multilayer pressure sensitive adhesive assembly according to any one of items 1 to 42, which has a peel strength value of more than 30 N/10 mm, more than 35 N/10 mm, or more than 40 N/10 mm, when measured at 23° C. on stainless steel according to the peel test method described in the experimental section.

Item 44 is a multilayer pressure sensitive adhesive assembly according to any one of items 1 to 43, which has a peel strength value of more than 20 N/10 mm, more than 25 N/10 mm, or more than 30 N/10 mm, when measured at 23° C. on polypropylene according to the peel test method described in the experimental section.

Item 45 is a multilayer pressure sensitive adhesive assembly according to any one of items 1 to 44, having an odor level of not more than 3 according to VDA270.

Item 46 is a process for manufacturing a multilayer pressure sensitive adhesive assembly according to any one of items 1 to 45, which comprises melt co-extruding, in particular hotmelt co-extruding, the polymeric foam layer, the first pressure sensitive adhesive layer, and optionally, the second pressure sensitive adhesive layer.

Item 47 is a process for manufacturing a multilayer pressure sensitive adhesive assembly according to any one of items 1 to 45, the process comprising:
compounding the multi-arm block copolymer and the at least one hydrocarbon tackifier to form a pressure sensitive adhesive formulation; and
melt co-extruding the polymeric foam layer and the pressure sensitive adhesive formulation to form the multilayer pressure sensitive adhesive assembly.

Item 48 is a process according to item 46 or 47, further comprising vacuum degassing at least one of the pressure sensitive adhesive formulation or the polymeric foam layer.

Item 49 is a process according to any of items 46 to 48, further comprising incorporating a volatile organic compound (VOC) entraining additive into at least one of the pressure sensitive adhesive formulation or the polymeric foam layer, wherein the VOC entraining additive is selected from the group consisting of water, carbon dioxide, nitrogen gas, and any combinations thereof.

Item 50 is a process according to any of items 46 to 49, further comprising crosslinking the hotmelt co-extruded multilayer pressure sensitive adhesive assembly with actinic radiation or with e-beam irradiation.

Item 51 is the use of a multilayer pressure sensitive adhesive assembly according to any one of items 1 to 45 for industrial applications, interior applications, construction market applications, automotive applications, or electronic applications.

Item 52 is the use according to item 51 for automotive applications, in particular for at least one of taped seal on body, taped seal on door, exterior and interior parts attachment, and weather-strip tape applications.

Item 53 is the use of a multilayer pressure sensitive adhesive assembly according to any one of items 1 to 45 for bonding to a low surface energy substrate and/or a medium surface energy substrate.

The present disclosure is further illustrated by the following examples. These examples are merely for illustrative purposes only and are not meant to be limiting on the scope of the appended claims.

### EXAMPLES

Unless otherwise noted, all parts, percentages, ratios, etc. in the Examples and the rest of the specification are by weight. The following abbreviations are used in this section: mg=milligram, g=gram kg=kilogram, centimeter=cm, mm=millimeter, nm=nanometer, mL=milliliter, ° C.=degrees Celsius, N=Newton, h=hour, rpm=rotations per minute, kV=kilovolt, MR=Mega rad, min=minutes, SS=stainless steel, PP=polypropylene, and PS=polystyrene.

TABLE 1
Materials List

| DESIGNATION | DESCRIPTION |
|---|---|
| FN100MD | Expandable microspheres (EMS) (average particle size of 5 to 50 μm), thermo |
| | expandable microcapsules from thermoplastic resins, obtained under the trade |
| | designation, “FN100MD” from Matsumoto Yushi-Seiyaku Co., Ltd, Osaka, |
| | Japan |
| DUALITE U010-185D | Expandable microspheres (EMS) (average particle size of 20 to 30 μm), |
| | thermo expandable microcapsules from thermoplastic resins, obtained under |
| | the trade designation, “DUALITE U010-185D”, from Henkel, Düsseldorf, |
| | Germany |
| KURARYCOAL | Carbonaceous, highly absorptive medium that has a complex structure |
| PGW-20MD | composed primarily of carbon atoms, obtained under the trade designation, |
| | “KURARAYCOAL PGW-20MD”, from KURARAY CHEMICAL CO., |
| | LTD., Okayama, Japan |
| ESCOREZ 5340 | Hydrogenated Hydrocarbon Resin, obtained under the trade designation, |
| | “ESCOREZ 5340”, from ExxonMobil, Houston, TX |
| ESCOREZ 5615 | Aliphatic/Aromatic Hydrocarbon Resin, obtained under the trade designation, |
| | “ESCOREZ 5615”, from ExxonMobil, Houston, TX |
| KRATON D1340 | Polymodal asymmetric styrene-isoprene-styrene star block copolymer and |
| | made according to U.S. Pat. No. 5,393,787, obtained under the trade |
| | designation, ″KRATON D1340”, from Kraton Performance Polymers, Inc., |
| | Houston, TX |
| KRATON D1161 | Linear styrene-isoprene-styrene block copolymer having a styrene content of |
| | 15%, obtained under the trade designation, “KRATON D1161”, from Kraton |
| | Performance Polymers, Inc., Houston, TX |
| IGRANOX 1010 | Heat stabilizer, obtained under the trade designation, “IGRANOX 1010”, |
| | from BASF GmbH, Ludwigshafen, Germany |
| ESACURE ONE | Difunctional alpha-hydroxy ketone photoinitiator, obtained under the trade |
| | designation, “ESCACURE ONE”, from IGM Resins, Waalwijk, Netherlands |
| 2-Ethylhexyl acrylate | 2-Ethylhexyl acrylate obtained from BASF GmbH, Ludwigshafen, Germany |
| Acrylic Acid | Acrylic acid obtained from Merck KGaA, Darmstadt, Germany |
| IOTG | Isooctyl thioglycolate, chain transfer agent obtained from TCI Deutschland |
| | GmbH, Eschborn, Germany |

### Test Methods

### Density Calculation

The density of the 3-layer foam tape constructions was determined by dividing the coating weight (in kg/in²) by the thickness of the tape (in in). The coating weight was measured by weighing a sample of 100 cm² cut out of the sample layer using a circle cutter. The coating weight is then converted in kg/in². The thickness of the foam tape was measured using a thickness gauge from Mitutoyo, Japan.

90°-Peel-Test at 300 mm/min (According to FINAT Test Method No. 2, 8th Edition 2009)

Multilayer pressure sensitive adhesive assembly strips according to the present disclosure and having a width of 10 mm and a length>120 mm are cut out in the machine direction from the sample material.

For test sample preparation, the liner is first removed from the one adhesive side and placed on a test coupon (stainless steel, polypropylene, or polystyrene) having the following dimensions: 22×1.6 cm, 0.13 mm thickness. The stainless steel is available from Rocholl GmbH, Eschelbronn, Germany; the polypropylene is available from Aquarius Plastics Ltd., Guildford, Surrey, Great Britain; and the polystyrene is available from Rocholl GmbH, Eschelbronn, Germany. Then, the adhesive coated side of each PSA assembly strip was placed, after the liner was removed, with its adhesive side down on a clean test panel, using light finger pressure. Next, the test samples were rolled twice with a standard FINAT test roller (weight 6.8-kg) at a speed of approximately 10 mm per second to obtain intimate contact between the adhesive mass and the surface. After applying the PSA assembly strips to the test panel, the test samples were allowed to dwell for 72 h at ambient room temperature (23° C.+/−2° C., 50% relative humidity+/−5%) prior to testing.

For peel testing, the test samples were in a first step clamped in the lower movable jaw of a Zwick tensile tester (Model Z020, commercially available from Zwick/Roell GmbH, Ulm, Germany). The multilayer pressure sensitive adhesive film strips were folded back at an angle of 90° and their free ends grasped in the upper jaw of the tensile tester in a configuration commonly utilized for 90° measurements. The tensile tester was set at 300 mm per minute jaw separation rate. Test results were expressed in Newton per 10 mm (N/10 mm). The quoted peel values were the average of two 90°-peel measurements. The failure mode was generally foam split unless otherwise noted.

Static Shear Test (70° C., 90° C., and 105° C. with 5007 (FINAT Test Method No. 8, 8th Edition 2009)

The test was carried out at 70° C., 90° C., or 105° C. The stainless steel is available from Rocholl GmbH; the polypropylene is available from Aquarius Plastics Ltd.; and the polystyrene is available from Rocholl GmbH. Test specimens were cut out having a dimension of 12.7 mm by 25.4 mm. The liner was then removed from one side of the test specimen, and the adhesive was adhered onto to an aluminum plate having the following dimension 25.4×50×1 mm thickness and comprising a 10-mm hole for the weight. The second liner was thereafter removed from the test specimen and the small panel with the test specimen was applied onto the respective test panel having the following dimensions: 50 mm×50 mm×2 mm at the short edge.

Next, the test samples were rolled twice with a standard FINAT test roller (weight 6.8 kg) at a speed of approximately 5 mm per second to obtain intimate contact between the adhesive mass and the surface. After applying the pressure sensitive adhesive assembly strips to the test panel, the test samples were allowed to dwell for 24 h at ambient room temperature (23° C.+/−2° C., 50% relative humidity+/−5%) prior to testing. Each sample was then placed into a vertical shear-stand (+2° disposition) at 70° C. or 90° C. with automatic time logging. After 10 minutes dwell time in the oven, a 500 g weight was hung into the hole of the aluminum plate. The time until failure was measured and recorded in minutes. Per test specimen, two samples were measured.

### Thermal Desorption Analysis of Organic Emissions According to VDA Test Method 278

VDA method 278 is a test method used for the determination of organic emissions from non-metallic trim components used to manufacture the interior of motor vehicles (VDA stands for “Verband der Automobilindustrie”, the German Association of Automobilists). The method classifies the emitted organic compounds into two groups:
VOC value—the sum of volatile and semi-volatile compounds up to n-C₂₅ and
FOG value—the sum of the semi-volatile and heavy compounds from n-C₁₄ to n-C₃₂

For measuring the VOC and FOG values, adhesive samples of 30 mg+/−5 mg were weighed directly into empty glass sample tubes. The volatile and semi-volatile organic compounds were extracted from the samples into the gas stream and are then re-focused onto a secondary trap prior to injection into a GC for analysis. An automated thermal desorber (Gerstel TDU 2 from GERSTEL GmbH & Co.KG, Mulheim an der Ruhr, Germany) was used for the VDA 278 testing.

The test method comprises two extraction stages:
VOC analysis, which involves desorbing the sample at 90° C. for 30 minutes to extract VOC's up to n-C₂₅. This was followed by a semi-quantitative analysis of each compound as μg toluene equivalents per gram of sample.
FOG analysis, which involves desorbing the sample at 120° C. for 60 minutes to extract semi-volatile compounds ranging from n-C₁₄ to n-C₃₂. This was followed by semi-quantitative analysis of each compound as μg hexadecane equivalents per gram of sample.

The VOC and FOG values expressed were the average of two measurements per sample.

### Odor Test According to VDA Test Method 270 C3

The odor test is executed based on a method derived from VDA test method 270 C3 as per the following procedure.

200 cm² samples of the exemplary multilayer construction were placed into 1000 mL glass bottles which were placed in an oven at 80° C. After 2 hours, the bottles were taken from the oven and allowed to cool to a temperature of 60° C. and then rated by at least three testers according to the rating used in VDA270 (see below) in Table 2.

TABLE 2
Ratings for VDA Test Method

| | |
|---|---|
| 1 | Not perceptible |
| 2 | Perceptible, not disturbing |
| 3 | Clearly perceptible, but not |
| | disturbing |
| 4 | Disturbing |
| 5 | Strongly disturbing |
| 6 | Not acceptable |

### Acrylic Polymer Preparation

The Acrylic Polymer used for the Core Formulations, below, was prepared as described for Polyacrylate polymers P1 and P2 in U.S. Pat. Appl. Pub. No. 2019/0345367 (Eckhardt et al.) using Pre-polymerized composition 1 with the modification that 0.048 parts IOTG was used and 0.4 parts ESACURE ONE photoinitiator was used instead of IRGACURE 651 photoinitiator.

### Skin Adhesive Preparation

Pressure sensitive skin adhesive formulations with compositions described in Table 3 (see below) were compounded in a 26-mm co-rotating twin screw extruder (ZSK26, Coperion GmbK, Stuttgart, Germany) having 15 heat zones (Z1 to Z15) and a L/D (length/diameter) ratio of 60.

TABLE 3
Composition of the Pressure Sensitive
Skin Adhesive (in weight parts)

| Skin | | | | | | | | |
|---|---|---|---|---|---|---|---|---|
| Materials | Skin1 | Skin2 | Skin3 | Skin4 | Skin5 | Skin6 | Skin7 | Skin8 |
| D1340 | 30 | 30 | 30 | 30 | 30 | 30 | 30 | 30 |
| D1161 | 20 | 15 | 25 | 30 | 20 | 15 | 25 | 30 |
| E5615 | 50 | 55 | 45 | 40 | 0 | 0 | 0 | 0 |
| E5340 | 0 | 0 | 0 | 0 | 50 | 55 | 45 | 40 |
| Irganox1010 | 1 | 1 | 1 | 1 | 1 | 1 | 1 | 1 |

The block copolymer blend and tackifier were fed in Z1 by solid feeding—loss in weight screw feeder (Single screw feeder DDW-MD3-DSR28N-10Q, Brabender Technologie GmbH & Co. KG, Duisburg, Germany). Vacuum was applied in Z10. The screw speed of the twin screw extruder was 300 rpm, and the throughput was around 10 kg/h. The temperature profile and the extrusion conditions are described in Table 4 (see below).

TABLE 4
Temperature Profile and Extrusion Conditions for Skin Adhesives

| | Temperature (° C.) | Temperature (° C.) | |
|---|---|---|---|
| Zone | Skins 1 to 4 with E5615 | Skins 5 to 8 with E5340 | Description |
| Z1 | 20 | 20 | Solid Feeding Compositions |
| Z2 | 40 | 40 | |
| Z3-Z4 | 170 | 180 | |
| Z5-Z9 | 160 | 180 | |
| Z10 | 160 | 180 | Vaccum Applied 80 mbar |
| Z11-Z15 | 160 | 180 | |
| Gear Pump | 160 | 180 | |
| Hose | 160 | 180 | |
| Outer Channel | 160/180 | 160/180 | Coating of the 3-layer |
| of 3-layer die | | | PSA/foam tape |

### Core Formulations

Foam core formulations described in Table 5 (see below) were compounded in a 30 mm co-rotating twin screw extruder (ZE30Ax64D UTXi, Krauss Maffei Berstorff GmbK, Hannover, Germany) having 23 heat zones (Z1 to Z23) and a L/D (length/diameter) ratio of 64.

TABLE 5
Pressure Sensitive Adhesive Foam Core Composition (in weight parts)

| Material | Core1 | Core2 | Core3 | Core4 | Core5 |
|---|---|---|---|---|---|
| Acrylic Polymer | 100 | 100 | 100 | 100 | 100 |
| EMS FN100MD | 3 | 3 | 3 | 3 | 0 |
| EMS DUALITE U010- | 0 | 0 | 0 | 0 | 3.6 |
| 185D | | | | | |
| Activated Carbon | 0 | 2 | 4 | 6 | 6 |

The temperature profile of the core extruder and the extrusion conditions are described in Table 6 (see below). The screw speed of the twin screw extruder was at 260 rpm and the throughput was 25 kg/h. The acrylic polymer was fed in the twin screw extruder in Zone Z2 using an acrylate feeder. Activated carbon was added in Zone Z1 using loss in weight screw feeder from (Double screw feeder DDW-M-DDSR20, Brabender Technologie GmbH & Co. KG, Duisburg, Germany). The expandable microspheres FN100MD were added in Zone Z12 employing a loss in weight twin screw feeder (Double screw feeder DDW-M-DDSR20, Brabender Technologie GmbH & Co. KG). Between the extruder and the die, the adhesive melt was metered by a gear pump (GPA36136-03 12Z CW, Nordson PPS GmbK, Munster, Germany) (140° C.) through a heated hose (140° C.) which made the junction between the extruder and the die. The temperature of the coating die was set at 160° C. The expandable microspheres could only expand after passing the 3-layer die at the end of the extrusion process, leading to a 3-layer foamed tape.

TABLE 6
Temperature Profile and Extruder Conditions of Core Adhesive

| Zone (Barrel) | Temperature (° C.) | Description |
|---|---|---|
| Z1 | 45 | Solid feeding activated carbon using a gravimetric |
| | | loss in weight |
| Z2 | 90 | Acrylic polymer feeding by acrylate feeder |
| Z3 | 105 | |
| Z4 | 115 | |
| Z5 to Z7 | 160 | |
| Z8 to Z11 | 120 | |
| Z12 | 120 | Feeding of EMS FN100MD using a gravimetric loss |
| | | in weight twin screw feeder from Brabender and a |
| | | twin screw side stuffer from Werner und Pfleiderer. |
| Z13 to Z14 | 120 | |
| Z15 to Z23 | 140 | |
| Gear pump | 140 | |
| Hose | 140 | |
| Middle channel | 160 | Coating and expansion of the microspheres. |
| of 3 Layer Die | | |

### Examples 1 to 6 (Ex1 to Ex6) and Illustrative Examples A to H (IIIExA to IIIExH5)

The extruded 3-layer foam constructions were coated onto a red siliconized polyethylene liner and cured by e-beam radiation with 260 kV and 8.5 MR intensity. The Examples were subjected to the test methods described above, and the results are shown in Tables 7 and 8, below.

Adhesives obtained from Tesa SE, Norderstedt, Germany, were also evaluated as comparative examples. Tesa “7065” adhesive was measured to have a VDA278 VOC of 2540 ppm, a VDA278 FOG of 7870 ppm, and a VDA27C3 odor rating of 5.2. Results for Tesa “92111” adhesive are shown in Table 7, below, under Comparative Example 1 (CE 1).

The results in Table 8 show good peel and static shear adhesive performance for Skins 2 to 4 and 6 to 8. Any of these skins can be combined with any of Cores 2 to 6 and would be expected to have desirable VOC, FOG, and odor values as shown in Examples 1 to 7 in Table 7.

TABLE 7
Example Results

| Example | CE1 | IllExA | Ex1 | Ex2 | Ex3 | Ex4 | Ex5 | Ex6 | Ex7 |
|---|---|---|---|---|---|---|---|---|---|
| Composition | | Skin1/ | Skin1/ | Skin1/ | Skin1/ | Skin5/ | Skin5/ | Skin5/ | Skin5/ |
| | | Core1 | Core2 | Core3 | Core4 | Core2 | Core3 | Core4 | Core5 |
| Density (g/cm³) | | 0.56 | 0.56 | 0.52 | 0.56 | 0.59 | 0.55 | 0.59 | 0.54 |
| 90° peel on SS | 22.3^{b} | 40.85 | 36.15 | 29.25 | 38.45 | 14.2^{a} | 13.65^{a} | 37.1 | 41.6 |
| (N/cm) | | | | | | | | | |
| 90° peel on PP | 48.5 | 40.45 | 35.45 | 32.65 | 23.5^{b} | 35.1 | 34.3 | 35.0 | 41.2 |
| (N/cm) | | | | | | | | | |
| 90° peel on PS | 47 | 30.32 | 36.5 | 30.5 | 40.8 | 36.1 | 32.4 | — | 42.2 |
| (N/cm) | | | | | | | | | |
| Static shear on | 3627 | 8582 | 10000 | 10000 | 10000 | 10000 | 10000 | 10000 | 10000 |
| SS 70° C. (min) | | | | | | | | | |
| Static shear on | | 594 | 1594 | 2639 | 5868 | 10000 | 10000 | 10000 | — |
| SS 90° C. (min) | | | | | | | | | |
| Static shear on | 7 | 2410 | 4043 | 6464 | 7294 | 10000 | 10000 | 9975 | 1061 |
| SS 105° C. (min) | | | | | | | | | |
| Static shear on | 2200 | 795 | 1235 | — | — | 10000 | 10000 | 10000 | 9012 |
| PP 70° C. (min) | | | | | | | | | |
| VOC (ppm) | 11000 | 1418 | — | 281 | 180 | — | 321 | — | 265 |
| Fog (ppm) | 14000 | 570 | — | 784 | 248 | — | 1145 | — | 161 |
| odor rating | 2.8 | 3.9 | — | 2.9 | 2.1 | — | 3.2 | — | 2.5 |

^{a}Pop-off failure and shocky behavior was observed.
^{b}Pop-off failure was observed.

TABLE 8
Illustrative Example Results

| Example | IllExB | IllExC | IllExD | IllExE | IllExF | IllExG | IllExH |
|---|---|---|---|---|---|---|---|
| Composition | Skin5/ | Skin2/ | Skin3/ | Skin4/ | Skin6/ | Skin7/ | Skin8/ |
| | Core1 | Core1 | Core1 | Core1 | Core1 | Core1 | Core1 |
| Density (g/cm³) | 0.52 | 0.54 | 0.56 | 0.54 | 0.51 | 0.53 | 0.53 |
| 90° peel on SS (N/cm) | 31.0 | 43.93 | 26.73 | 37.25 | 15.3^{a} | 36.2 | 32.0^{b} |
| 90° peel on PP (N/cm) | 36.0 | 31.15 | 29.13 | 35.65 | 33.7 | 35.4 | 32.8 |
| 90° peel on PS (N/cm) | 37.1 | 33.1 | 31.1 | 36.2 | — | — | — |
| Static shear on SS | 10000 | 10000 | 10000 | 10000 | 10000 | 10000 | 10000 |
| 70° C. (min) | | | | | | | |
| Static shear on SS | 4315 | 647 | 2611 | 1640 | 7281 | 7738 | 7286 |
| 90° C. (min) | | | | | | | |
| Static shear on SS | 3693 | 3967 | 1397 | 2324 | 2149 | 1972 | 958 |
| 105° C. (min) | | | | | | | |
| Static shear on PP | | 1124 | 1256 | 951 | 10000 | 10000 | 10000 |
| 70° C. (min) | | | | | | | |

^{a}Pop-off failure and shocky behavior was observed.
^{b}Pop-off failure was observed for one sample.

The preceding description, given to enable one of ordinary skill in the art to practice the claimed invention, is not to be construed as limiting the scope of the disclosure, which is defined by the claims and all equivalents thereto.

1. A multilayer pressure sensitive adhesive assembly comprising a polymeric foam layer and a first pressure sensitive adhesive layer adjacent to the polymeric foam layer, wherein the polymeric foam comprises a plurality of activated carbon particles distributed therein, and wherein the first pressure sensitive adhesive layer comprises:
a multi-arm block copolymer in an amount greater than 20 percent by weight, based on the total weight of the first pressure sensitive adhesive layer, the multi-arm block copolymer having formula Qₙ-Y,
wherein:
Q represents an arm of the multi-arm block copolymer and each arm independently has the formula G-R,
n represents the number of arms and is a whole number of at least 3, and
Y is the residue of a multifunctional coupling agent,
wherein each R is a rubbery block comprising a polymerized conjugated diene, a hydrogenated derivative of a polymerized conjugated diene, or combinations thereof, and each G is a glassy block comprising a polymerized monovinyl aromatic monomer; and
at least one hydrocarbon tackifier.

2. The multilayer pressure sensitive adhesive assembly of claim 1, wherein the first pressure sensitive adhesive layer comprises:
the multi-arm block copolymer in an amount ranging from 25 percent by weight to 60 percent by weight, based on the total weight of the first pressure sensitive adhesive layer;
the hydrocarbon tackifier in an amount of 40 percent by weight to 60 percent by weight, based on the total weight of the first pressure sensitive adhesive layer; and
a linear block copolymer having the formula L-(G)ₘ in an amount from 0 percent by weight to 35 percent by weight, based on the total weight of the first pressure sensitive adhesive layer, wherein:
L is a rubbery block comprising a polymerized olefin, a polymerized conjugated diene, a hydrogenated derivative of a polymerized conjugated diene, or any combinations thereof; and
G is a glassy block comprising a polymerized monovinyl aromatic monomer; and
wherein m is 1 or 2.

3. The multilayer pressure sensitive adhesive assembly of claim 2, wherein the rubbery block L of the linear block copolymer having the formula L-(G)ₘ, comprises at least one of polyisobutylene, polyisoprene, or polybutadiene, and wherein at least one glassy block G of the linear block copolymer having the formula L-(G)ₘ, comprises a polymerized mono vinyl aromatic monomer comprising at least one of styrene or an alkylated styrene.

4. The multilayer pressure sensitive adhesive assembly of claim 1, wherein the first pressure sensitive adhesive layer is substantially free of a (meth)acrylate copolymer having a glass transition temperature higher than 25° C., a weight average molecular weight from 1000 to 100,000 grams/mole, and comprising (meth)acrylic acid ester monomer units having a glass transition temperature higher than 25° C. when homopolymerized.

5. The multilayer pressure sensitive adhesive assembly of claim 1, wherein the first pressure sensitive adhesive layer is substantially free of a polymeric plasticizer having a weight average molecular weight of at least 10,000 grams/mole.

6. The multilayer pressure sensitive adhesive assembly of claim 1, wherein the polymerized conjugated diene in R comprises at least one of polyisoprene or polybutadiene, and wherein at least one of the glassy blocks of the multi-arm block copolymer having the formula Qₙ-Y comprises a polymerized monovinyl aromatic monomer comprising at least one of styrene or an alkylated styrene.

7. The multilayer pressure sensitive adhesive assembly of claim 1, wherein the multilayer pressure sensitive adhesive assembly is crosslinked by electron beam crosslinking.

8. The multilayer pressure sensitive adhesive assembly of claim 1, wherein the activated carbon particles have an individual specific surface area in a range from 100 m²/g to 2000 m²/g, when measured according to the BET nitrogen absorption test method.

9. The multilayer pressure sensitive adhesive assembly of claim 1, wherein the activated carbon particles are present in the polymeric foam in an amount in a range from 0.1 percent to 15 percent by weight, based on the total weight of the polymeric foam.

10. The multilayer pressure sensitive adhesive assembly of claim 1, wherein the polymeric foam comprises a polymer base material comprising at least one of a polyacrylate, a polyurethane, a polyolefin, a polyamine, a polyamide, a polyester, a polyether, a polyisobutylene, a polystyrene, natural rubber, a rubber-based elastomeric material, a polyvinyl, or polyvinylpyrrolidone.

11. The multilayer pressure sensitive adhesive assembly of claim 1, wherein the polymeric foam comprises:
from 60 to 100 wt %, based on the weight of the polymeric foam, of (meth)acrylate ester monomer units having a linear or branched alkyl group having from 1 to 32 carbon atoms;
from 0 to 40 wt % of acrylic acid monomer units, based on the weight of the polymeric foam; and
from 0 to 20 wt % of expandable microspheres based on the weight of the polymeric foam.

12. The multilayer pressure sensitive adhesive assembly of claim 1, wherein the at least one hydrocarbon tackifier has at least one of a Volatile Organic Compound (VOC) value of less than 1000 ppm, when measured by thermogravimetric analysis, or a Volatile Fogging Compound (FOG) value of less than 1500 ppm, when measured by thermogravimetric analysis.

13. The multilayer pressure sensitive adhesive assembly of claim 1, further comprising a second pressure sensitive adhesive layer adjacent to the polymeric foam layer opposite the first pressure sensitive adhesive layer, wherein the second pressure sensitive adhesive layer independently comprises:
a multi-arm block copolymer in an amount greater than 20 by weight, based on the total weight of the second pressure sensitive adhesive layer, the multi-arm block copolymer having formula Qₙ-Y,
wherein:
Q represents an arm of the multi-arm block copolymer and each arm independently has the formula G-R,
n represents the number of arms and is a whole number of at least 3, and
Y is the residue of a multifunctional coupling agent,
wherein each R is a rubbery block comprising a polymerized conjugated diene, a hydrogenated derivative of a polymerized conjugated diene, or combinations thereof, and each G is a glassy block comprising a polymerized monovinyl aromatic monomer; and
at least one hydrocarbon tackifier.

14. The multilayer pressure sensitive adhesive assembly of claim 1, having at least one of a Volatile Organic Compound (VOC) level of less than 500 ppm according to VDA278, a Volatile Fogging Compound (FOG) level of less than 1000 ppm according to VDA278, or an odor level of not more than 3 according to VDA270.

15. A process for manufacturing the multilayer pressure sensitive adhesive assembly of claim 1, the process comprising:
compounding the multi-arm block copolymer and the at least one hydrocarbon tackifier to form a pressure sensitive adhesive formulation; and
melt co-extruding the polymeric foam layer and the pressure sensitive adhesive formulation to form the multilayer pressure sensitive adhesive assembly.

16. The process of claim 15, further comprising crosslinking the multilayer pressure sensitive adhesive assembly with electron beam irradiation.

17. The multilayer pressure sensitive adhesive assembly of claim 13, wherein the first pressure sensitive adhesive layer and the second pressure sensitive adhesive layer have the same pressure sensitive adhesive composition.

18. The multilayer pressure sensitive adhesive assembly of claim 13, wherein the second pressure sensitive adhesive layer comprises:
the multi-arm block copolymer in an amount ranging from 25 percent by weight to 60 percent by weight, based on the total weight of the second pressure sensitive adhesive layer;
the hydrocarbon tackifier in an amount of 40 percent by weight to 60 percent by weight, based on the total weight of the second pressure sensitive adhesive layer; and
a linear block copolymer having the formula L-(G)ₘ in an amount from 0 percent by weight to 35 percent by weight, based on the total weight of the second pressure sensitive adhesive layer, wherein:
L is a rubbery block comprising a polymerized olefin, a polymerized conjugated diene, a hydrogenated derivative of a polymerized conjugated diene, or any combinations thereof; and
G is a glassy block comprising a polymerized monovinyl aromatic monomer; and
wherein m is 1 or 2.

19. The multilayer pressure sensitive adhesive assembly of claim 2, wherein a weight ratio of the multi-arm block copolymer to the linear block copolymer in the first pressure sensitive adhesive is in a range from 1:1 to 5.1.

20. The multilayer pressure sensitive adhesive assembly of claim 1, wherein the polymeric foam layer further comprises at least one filler material selected from the group consisting of expandable microspheres; expanded microspheres; gaseous cavities; glass microspheres; and combinations thereof.
